(19) United States
(12) Patent Application Publication
(10) Pub. No.: US 2007/0016512 A1
(43) Pub. Date: Jan. 18, 2007

(54) Real Time Bidding Systems and Methods

(76) Inventors: Peter Kelly, San Francisco, CA (US); Zachary E. Hallowell, San Francisco, CA (US); Clarence J. Hammond, Fremont, CA (US)

Correspondence Address: WILSON SONSINI GOODRICH & ROSATI, 650 PAGE MILL ROAD, PALO ALTO, CA, 94304-1050, US

(21) Appl. No.: 11/457,068

(22) Filed: Jul. 12, 2006

Related U.S. Application Data
(60) Provisional application No. 60/699,071, filed on Jul. 13, 2005.

(51) Int. Cl. G06Q 40/00

(52) U.S. Cl. 705/37

(57) ABSTRACT

Methods and systems for managing a network-based auction for vehicles. Information regarding a set of vehicles to be auctioned in an auction event is received from a seller through an electronic interface. A list of the vehicles to be auctioned is displayed on an interface for the seller. The seller is provided an option to determine an order in which the vehicles are to be made available to buyers for bidding on an interface on which the list is displayed. Input is received from the seller regarding the order, and the vehicles are made available to buyers for bidding in the order determined by the seller. Other methods and systems for managing a network-based auctions for vehicles are also described.

### CROSS-REFERENCE

This application claims the benefit U.S. Provisional Application No. 60/699,071, filed Jul. 13, 2005, which is incorporated herein by reference in its entirety.

This application is related to the following copending patent applications: application Ser. No. ______ [Attorney Docket No. 23459-701.202] for Real Time Bidding Systems and Methods with Question Interface, invented by Peter Kelly, Zachary E. Hallowell and Clarence J. Hammond, filed concurrently herewith; and application Ser. No. ______ [Attorney Docket No. 23459-701.203] for Real Time Bidding Interface Systems and Methods, invented by Peter Kelly, Zachary E. Hallowell and Clarence J. Hammond, filed concurrently herewith.

### INCORPORATION BY REFERENCE

All publications and patent applications mentioned in this specification are hereby incorporated herein by reference to the same extent as if each individual publication or patent application was specifically and individually indicated to be incorporated by reference.

### BRIEF DESCRIPTION OF THE DRAWINGS

FIG. 1 is a block diagram of a system with a bidding tool, according to an embodiment of the invention.

FIG. 2 is a more detailed block diagram of a system with a bidding tool, according to an embodiment of the invention.

FIG. 3 is a block diagram of a seller system of a bidding tool, according to an embodiment of the invention.

FIG. 4 shows a user interface for a seller showing events in a bidding tool, according to an embodiment of the invention.

FIG. 5 shows a user interface for a seller showing an auction catalog in a bidding tool, according to an embodiment of the invention.

FIG. 6 shows a user interface for a seller for updating order of items in an auction catalog in a bidding tool, according to an embodiment of the invention.

FIG. 7 shows a user interface for a seller for updating reserve price in an auction catalog in a bidding tool, according to an embodiment of the invention.

FIG. 8 shows a user interface for a seller for editing a vehicle work page in an auction catalog in a bidding tool, according to an embodiment of the invention.

FIG. 9 shows a user interface for a seller for assigning lifecycle in a bidding tool, according to an embodiment of the invention.

FIG. 10 shows a user interface for a seller for editing pricing in a bidding tool, according to an embodiment of the invention.

FIG. 11 shows an auction console interface for a seller in a bidding tool, according to an embodiment of the invention.

FIG. 12 is a block diagram of a buyer system of a bidding tool, according to an embodiment of the invention.

FIG. 13 shows a user interface for a buyer showing an auction calendar in a bidding tool, according to an embodiment of the invention.

FIG. 14 shows a user interface for a buyer showing an auction catalog in a bidding tool, according to an embodiment of the invention.

FIG. 15 shows a user interface for a buyer with a question input in a bidding tool, according to an embodiment of the invention.

FIG. 16 shows a user interface for a buyer showing item detail in a bidding tool, according to an embodiment of the invention.

FIG. 17 shows an auction console interface for a buyer in a bidding tool, according to an embodiment of the invention.

FIG. 18 shows a user interface for a buyer showing items purchased in a bidding tool, according to an embodiment of the invention.

FIG. 19 shows a user interface for an administrator in a bidding tool, according to an embodiment of the invention.

FIG. 20 is a block diagram of an auction server of a bidding tool, according to an embodiment of the invention.

### DETAILED DESCRIPTION

An embodiment of the invention is directed to a bidding tool. A dynamic market environment is provided in which buyers interactively bid against each other for items, such as vehicles. The items are offered in sequential order. The time in which bids may be placed is compressed into a reduced window of time. The tool is network-based. The buyers, sellers, and auction system communicate by way of a computer network such as the Internet. An embodiment of the invention is directed to a tool for selling vehicles. Thus, according to an embodiment of the invention, the items in the auction are vehicles. Other embodiments of the invention are directed to selling of other items, and the principles described herein with respect to vehicles may be applied to such other items.

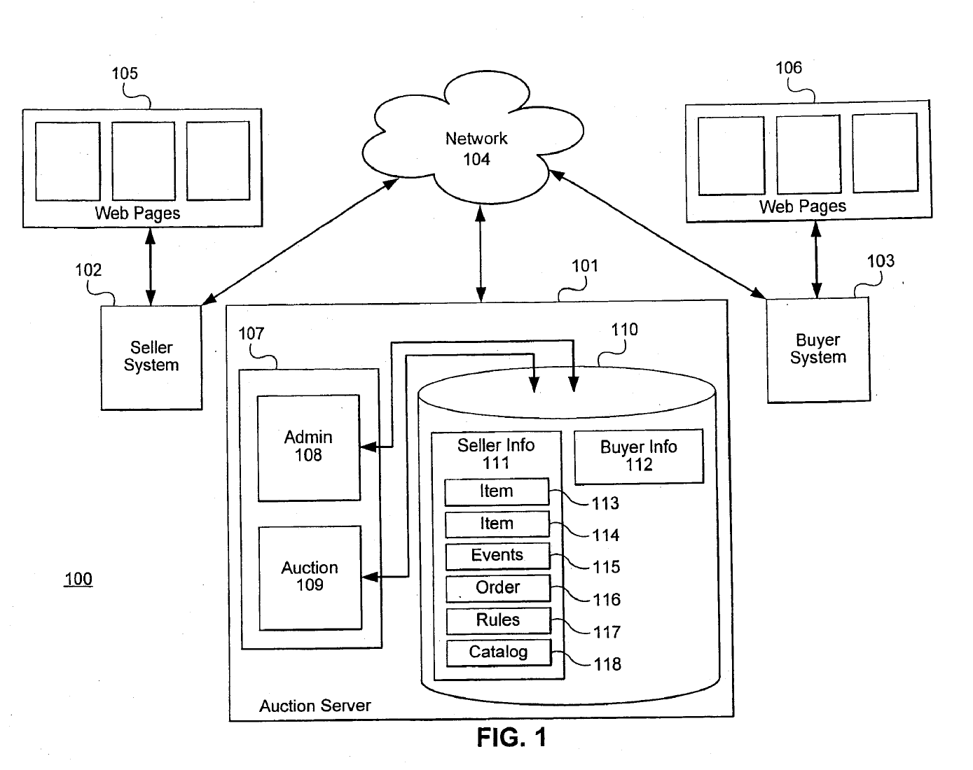

FIG. 1 is a block diagram of a system with a bidding tool, according to an embodiment of the invention. The system includes an auction server 101, seller system 102, and buyer system 103. Also shown is network 104. Seller system 102 includes web pages 105, and buyer system 103 includes web pages 106. Auction server 101 includes software 107 and storage 110. Software 107 includes administrative software 108 and auction software 109, and storage includes seller information 111 and buyer information 112. Seller information 111 includes information such as vehicle information 113 and 114, and events information 115 which includes order 116, rules 117 and catalog 118. Auction server 101 is coupled to seller system 102 and buyer system 103 via network 104. Software 107 in auction server 101 operates with storage 110.

Seller system 102 includes functionality to manage inventory (such as vehicles), set up and modify bidding events, and manage bidding events. Such functionality may be included directly in seller system 102 or may be included in auction server 101 or in a combination of software or other logic located in seller system 102 and auction server 101.

Buyer system 103 includes functionality to view catalog items for bidding, to place bids and view an auction, and to select purchase, payment and delivery options for items purchased. This functionality may be included in functionality on buyer system 103, auction server 101 and/or combination of functionality located on auction server 101 and buyer system 103. The functionality may be implemented in software, hardware, or a combination of hardware and software according to various embodiments. Thus, according to various embodiments, the implementations described herein for software may also be implemented in various configurations of software and/or hardware, in distributed or other configurations in various machines and/or networks.

Auction server 101 includes software and storage to manage options and the users of the auctions. Administrative software 108 manages users and information related to users, such as seller information 111 and buyer information 112. Auction software 109 controls an auction including the progress of the auction as requested by seller system 102 and response to bids made by buyer system 103.

Seller system 102 includes web pages 105 that allow seller to enter and display information regarding auction events, inventory, and related administration.

Buyer system 103 includes web pages 106 that allow a buyer to display information regarding bidding as well as enter information commands in order to participate in bidding in auctions.

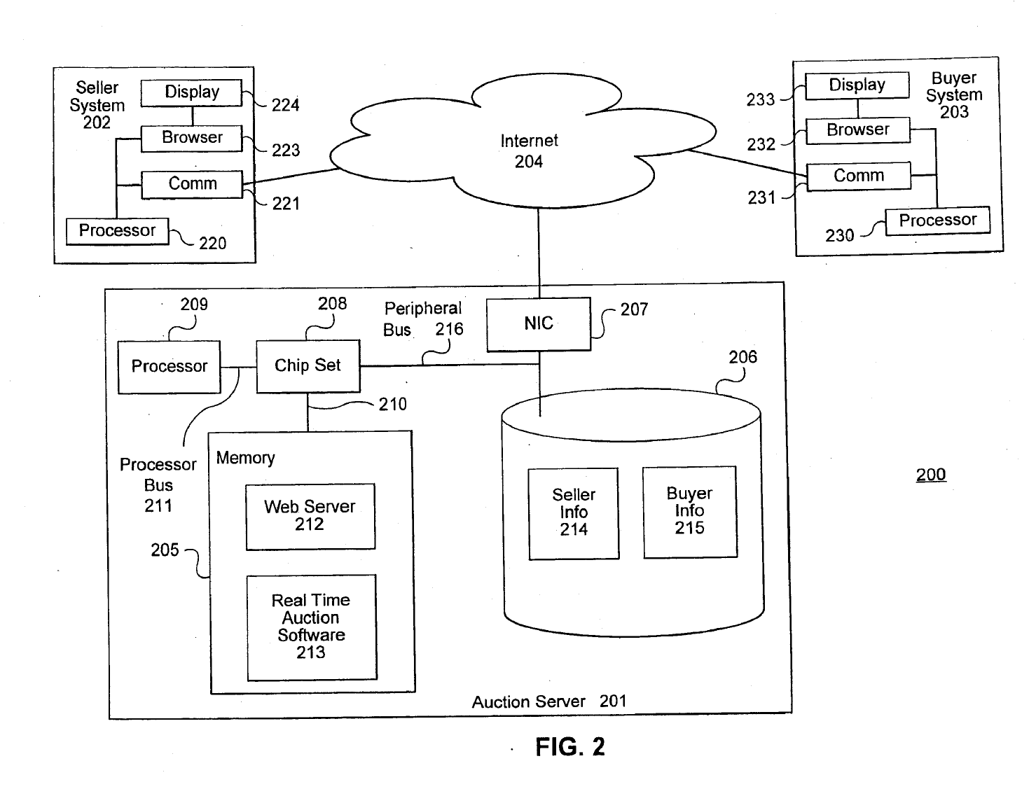

FIG. 2 is a more detailed block diagram of a system with a bidding tool, according to an embodiment of the invention. Included in system 200 are auction server 201, seller system 202, and buyer system 203. Auction server 201 is coupled to seller system 202 and buyer system 203 through Internet 204. FIG. 2 shows a more detailed view of architecture of the various components of the auction system. Auction sever 201 may include a processor 209 for processing instructions, such as an Intel Pentium™ processor, AMD Athlon™ processor or other processor. Processor 209 is coupled to chip set 208 by a processor bus 211. Chip set 208 is coupled to memory 205 by a memory bus 210 and manages access to memory 205 by processor 209. Chip set 208 is also coupled to peripheral bus 216. Peripheral 216 bus may comprise, for example, PCI, PCI-X, PCI Express, or other peripheral bus. Auction server 201 also includes one or more network interface cards 207 coupled to peripheral bus 216 for providing network interfaces to network, such as Internet 204. Storage 206, such as a disk array or other non-voltage storage, is also coupled to peripheral bus 216.

According to various embodiments, memory 205 and/or storage 206 may include various forms of storage or computer-readable memories such as, but not limited to, volatile memory (random access memory (“RAM”), non-volatile memory (read-only memory (“ROM”)), EEPROM, disk, and/or other storage devices that may include one or more of magnetic, optical storage, or other media. The memory and/or storage on the auction server may be configured as a RAID (Redundant Array of Independent Disks) configuration to provide high reliability access to software and data.

Software may be loaded into memory 205 to help provide auction/bidding function for auction server 201. For example, web server 212 and real-time auction software 213 may be loaded into memory 205 and run by process 209. Web server 212 provides web pages for the users to interact with in order to be provided with auctions/bidding functions. For example, web server 212 may serve up web pages to seller system 202 and buyer system 203 in order to allow seller system 202 to manage inventory events and bidding and to allow buyer system 203 to view events and auction items to make bids and to participate in auctions. Storage 206 includes information about respective users, such as seller information 214 and buyer information 215. This information is used in order to manage the inventory of items for sale, configuration of bidding events, and the processing of real-time bidding. According to various embodiments of the invention, auction system 200 may include one or a plurality of auction servers 201 in various configurations and architectures to provide auctions and bidding functionality.

Seller system 202 and/or buyer system 203 may comprise computer systems coupled to a network such as Internet 204 according to an embodiment. As shown, seller system 202 includes processor 220 and software components such as a browser 223 and communications software 221. Also included is a display 224 that allows a user to see information regarding auctions and to perform related administration. Buyer system 203 also includes a processor 230, communication software 231, browser 232, and display 233. Various browser software or other software or functionality to provide user interaction may be used in buyer and seller systems. For example, browsers may include, but are not limited to, Internet Explorer, Netscape browser, Firefox browser, Safari browser or other browser. Alternatively, other user interface software not including a browser may be used.

Software such as web server 212 and real-time auction software 213 may be stored in storage 206 or other storage and may be loaded into memory 205 for manipulation by processor 209 according to an embodiment of the invention. Portions of data such as seller information 214 and buyer information 215 may be loaded into data structures in memory 205 or other storage for manipulation by processor 209 in accordance with software such as web server 212 and real-time auction software 213. Web server 212 includes an operating system for managing system resources, such as Microsoft Windows XP, 2000, 98, or NT, Apple OS, Linux, or other operating systems as well as applications software running on top of the operating systems for implementing an HTML server or other server. Information stored in storage 206 may be stored in various forms of database arrangements and may contain cross references or links to one another to allow information to be queried and retrieved. In an example embodiment, the information is stored in databases, such as relational databases, and may be queried using structured query language (SQL) or other mechanism.

The system may include a secure connection or connections. For example, in an embodiment of the invention, the entire bidding operation of the system operates on a secure connection or connections. Various different technologies may be used to provide a secure connection, such as encryption with, for example, public key and private key encryption. The system may be set up over a virtual private network (VPN).

In an example embodiment, a seller operates seller system 202 through browser 223, communications software 221, and display 224 to set up seller inventory and seller events in seller information storage 214. The seller-user also manages the events and bidding through seller system 202, which communicates via Internet 204 with web server 212.

Buyer system 203 interacts with a buyer user, allowing the buyer user to view items and events including the items for auction. The interaction is provided to the buyer user through display 233, browser 232, and communications software 231, which are controlled by processor 230. Buyer system in turn communicates with auction server 201 via Internet 204. Web server 212 in turn provides buyer system 203 with graphical interface pages which may be displayed on display 233.

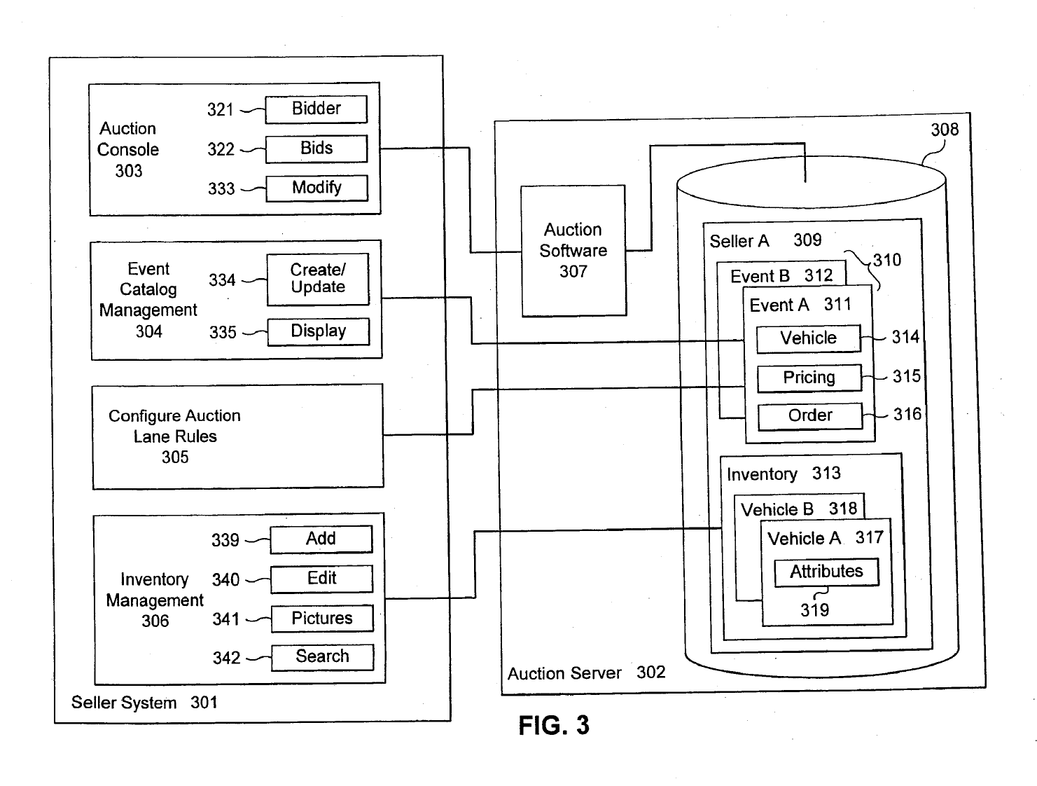

FIG. 3 is a block diagram of a seller system of a bidding tool, according to an embodiment of the invention. Shown is seller system 301, which is coupled to auction server 302. Seller system 301 includes auction console 303, event catalog management logic 304, configure auction lane rules logic 305, and inventory management logic 306. Auction server 302 may include various components of an auction server described herein. For example, as shown here, auction server 302 includes auction software 307 and storage 308. Storage 308 may include seller data 309, which includes data regarding the seller, such as events 310 (event A 311 and event B 312) and Inventory 313. Events such as event A 311 may include vehicle information 314, such as VIN, year, make, model and/or other attributes, pricing information 315, and order information 316. Inventory 313 may include information regarding vehicles such vehicle A 317 (with attributes 319) and vehicle B 318.

Various components of seller system 301 contain functionality to provide an auction system function for a seller, and these may be coupled to auction server 302 in order to provide such functionality. The coupling from seller system 301 to auction server 302 may be provided via a network, such as the Internet as described herein. Additionally, the various aspects of the logic blocks shown in seller system 301 may be provided through software and/or hardware residing on auction server 302, or in seller system 301, or a combination of elements in auction server 302 and seller system 301. According to one embodiment, software providing the logic of the various components of seller system 301 is provided through software on auction server 302. This software on auction server 302 provides web pages through a web server, and the respective web pages are displayed by seller system 301.

Various logical components of seller system 301 communicate with corresponding aspects of auction server 302, and such communication may take place through hardware and software components not shown. Auction console 303 includes an interface showing bidders 321, an interface showing bids 322, and an interface allowing the user to modify 333 the auction. Auction console 303 is coupled to software in auction server 302, such as auction server software 307, which provides information regarding, and control of, an auction. Event catalog management logic 304 includes functions such as creating and/or updating 334 events and/or catalog of events and display 335 of events and/or catalog of events. Such functionality communicates with and controls the respective aspects of auction server 302, for example, by updating an event, such as event A 311 of seller data 309. Configure auction lane rules logic 305 also causes the appropriate changes to be made in the data stored in storage 308 regarding a particular auction to which the rules apply. For example, as shown here, configure auction lane rules logic 305 is coupled to event A 311, for changing the rules associated with event A 311. Inventory management logic 306 allows a seller-user of seller system 301 to manage the entries regarding the seller's inventory. This management includes, according to various embodiments, add logic 339, editing logic 340, uploading and management of pictures logic 341 and/or search logic 342. Inventory management logic 306 causes appropriate modifications to take place in the representation of inventory 313, which is stored in seller data 309 in storage 308 of auction server 302.

Thus, a seller-user of seller system 301 is able to participate in auctions by managing an inventory of items, such as vehicles, to be sold through inventory management logic 306, providing and managing catalog of events through which vehicles may be sold through event catalog management logic 304 and monitoring and participating in the auction through event console 303. The system provides software, which may be implemented in seller system 301, auction server 302 or in software located in both seller system 301 and auction server 302 that allows a seller to assign a vehicle to a real-time bidding event, set run orders and pricing, review and accept bids in real-time and supply the seller with relevant vehicle data including market-based pricing.

An embodiment of the invention includes functionality to create a seller-user and/or user permissions for the seller-user. According to an embodiment of the invention, the system creates a representation of a seller as an organization, such as an institutional selling organization in the system. The institutional selling organization is then able to list vehicles in real-time bidding events. The creation of the seller organization may involve creation of a record, such as seller data 309 stored in storage 308 of auction server 302. The seller is associated with respective events such as events 310 shown in storage 308. Note that events 310 maybe stored in various data structures related to seller data 309. These data structures may be included in the particular data structure associated with the seller, such as seller data 309, or may be stored separately from but associated with seller data 309.

Various levels of user permissions may be configured for a seller organization. For example, according to an embodiment of the invention, a seller has an organizational type of “institutional.” The seller has a “role” of “seller reports” and “edit vehicles” in order to view an auction lane and/or event and manage the auction lane and/or set prices.

For example, in one embodiment, if a user is provided a “seller reports” role for viewing an auction lane and/or event, but the user is not provided the permission to edit vehicles, then the user only has the ability to view and not the ability to edit auction items such as vehicles. If a user is provided permission to edit vehicles, then the user does have the ability to edit vehicles. For example, if an event exists for the seller, the respective user with the permission to edit vehicles can associate a vehicle with the event.

The system includes logic to allow a seller to manage bidding events and associated activities. Accordingly, the system includes logic, such as software, hardware, and/or a combination of hardware and software that provides functionality to implement activities before, during, and after a sale including assigning vehicles to an event, setting prices, establishing a run list, accepting bids, and determining the disposition of vehicles that are not sold.

After a representation of a seller has been created in the system, one or more event(s) may be created and associated with the seller. According to an embodiment of the invention, seller-users belonging to seller organizations that are associated with at least one event, and have the respective permissions, will be able to access event(s). According to an embodiment of the invention, access to events is provided to a seller system through access to a “sell” navigation button or other button designated for selling. When a seller-user clicks the link or button, the system presents the user with a new page listing events associated with the seller. According to an embodiment of the invention, current, active events are shown at the top of the interface, and a link is provided that activates auction console 303. Under the respective link is a list of or link to future events and/or past events.

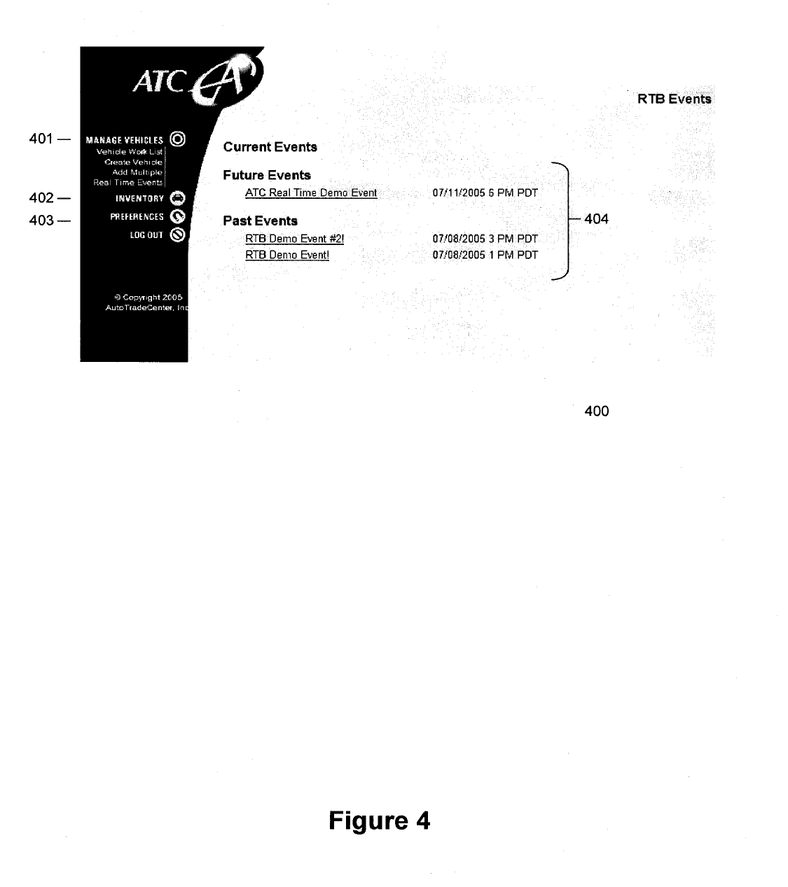

FIG. 4 shows a user interface for a seller showing events in a bidding tool, according to an embodiment of the invention. This and/or other interfaces shown herein may be provided through a web page, and may be transmitted in HTML format from a web server located, for example, on an auction server. The interface may comprise a catalog as discussed in this application. The view of the catalog may vary, depending on the status of the event and depending on the implementation of the user interface. The user interface 400 includes user inputs to manage vehicles 401, manage inventory 402, and set preferences 403. Also shown is a list of events 404 which may include clickable links or buttons that provide more detail regarding the respective events. As shown here, the list of events may be characterized as current events, future events, and past events.

According to one embodiment, the event list is provided on a calendar which may include the functionality of allowing the user to see the current month and scroll to previous and/or future months.

Upon the user selecting an event (such as by clicking an event link or button or making other selection on a user interface), the system presents the user with a catalog view for the event. The catalog view may vary, depending on the status of the event. The system provides functionality that allows a user to manage an event, and this functionality may be activated through a button or link on a catalog view page. For example, according to an embodiment, the catalog page has a box labeled “manage event” with an indication of the status of the event. The links or buttons may vary based on the status of the event. For example, if the event has not yet run (the start date is in the future), then the system provides links or buttons in the seller's interface “manage event” box to perform the following actions:
Event status: pre-event.
Set the run order and/or edit reserve prices.
If the status of the event is pre-auction, the system provides the seller the option to edit information in a vehicle work page.

An embodiment of the system provides display of auction fees as follows:
Fixed auction fees may be displayed, for example with text stating “fixed [fee] fee amount” per vehicle purchased.
If percentage fees are used, appropriate information is provided to the buyer regarding the percentage fee.
If tiered fees are provided, appropriate information is provided to the user indicating that tiered fees will be provided and the amount, for example, stating that, in a particular range, a particular fee is applicable, and such information is repeated for each particular tier.

Auction lane rules are displayed. The auction lane rules are displayed from the settlement information for the sale. This includes sections for title, transport and payment. The display may be similar to the way settlement information may display on open auction vehicles, with each section of settlement information separated by a header from the information above and below it.

If the event is in progress, links and/or buttons may appear on the display, such as in a managed event box, for example:
Event status: live event.
Link to an open console to view and/or accept bids and/or remove vehicles from the event.

If the event is closed, then in the display, such as in a managed event box, the system displays:
Event status: post event.
Determine disposition of items not sold, and present a block report outlining the results of the auction.

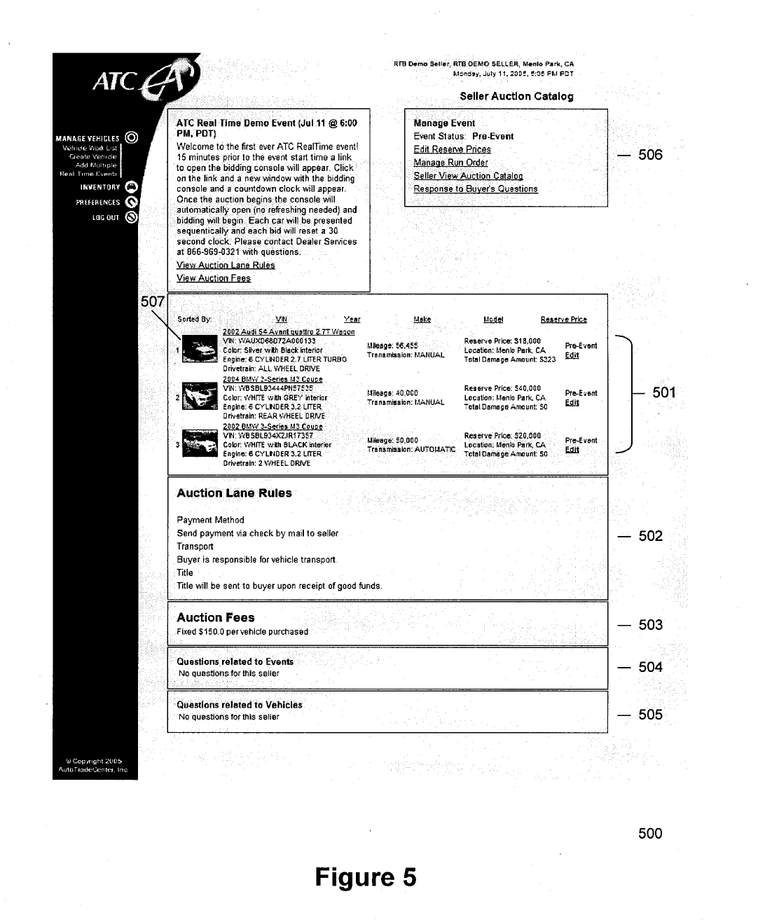

FIG. 5 shows a user interface for a seller showing an auction catalog in a bidding tool, according to an embodiment of the invention. The interface is shown generally as a screen 500 with multiple items of information and buttons or links that the user can select. Interface 500 includes a list 501 of vehicles in the catalog. Also included are auction lane rules 502, auction fees 503, questions related to events 504, and questions related to vehicles 505. List 501 of vehicles may include various columns such as VIN, year, make, model, and reserve price and/or other attributes. The list may be sorted by such respective items. As shown, the list may also include pictures, such as thumbnail images 507 of the respective items for auction. A manage event window 506 may be included which may provide status of the event, such as pre-event. Manage event window 506 may also include buttons or links to allow the seller-user to edit reserve prices, manage run order, view the auction catalog, and/or respond to buyer's questions.

According to an embodiment of the invention, auction lane settings may be provided and/or changed by users. According to an embodiment, the system sets auction lane settings based on user input provided by an administrator operating on auction server 302. Such administrative users have system configuration permission, according to an embodiment of the invention.

According to an embodiment of the invention, the seller-user is able to edit the order in which the items (such as vehicles) are auctioned in the event. An event catalog may list the vehicles in the event, and the list may be provided in the order in which the vehicles will be auctioned in the event. By clicking an appropriate button or link, such as a link entitled “update run list,” the system provides the user a new interface, such as a web page, where the user can set the order in which the vehicles are auctioned. Such page may contain information regarding the vehicles such as:
Vehicle identification number (VIN),
Year,
Make, model, series, body style and/or other information, with possibly a link to a detail page,
Location, such as city and state,
Reserve price,
Color (such as exterior and interior colors),
Mileage,
Mechanical characteristics of the item such as engine, drivetrain and/or transmission of the vehicle,
A link to a user interface page that would allow editing of the vehicle attributes.

According to an embodiment of the invention, the system provides functionality to sort items on the page. For example, the items may be sorted by VIN, year, make, model, and/or reserve price. Alternatively, the items may be sorted by other attribute(s).

The system provides the ability to set the order which the items are auctioned in various ways. For example, the system sorts items starting with the most desirable and moving to items that are progressively less desirable. In such ordering, the system may display a list of vehicles with the option of allowing a user to click and drag a vehicle up or down to the position in which the user would like the vehicle to be run in the auction. The system accepts information from the user and saves the new ordering. The system provides ordering of the items (vehicles) relative to which vehicles are the next desirable. The system provides interface in which next to the display of each vehicle an up and down arrow is provided, and in response to clicking on the respective arrow, the system moves the vehicle up or down in the display. According to an embodiment of the invention, the vehicle moves up or down in the display in less than one second. The system may save the new order in response to information submitted by the user.

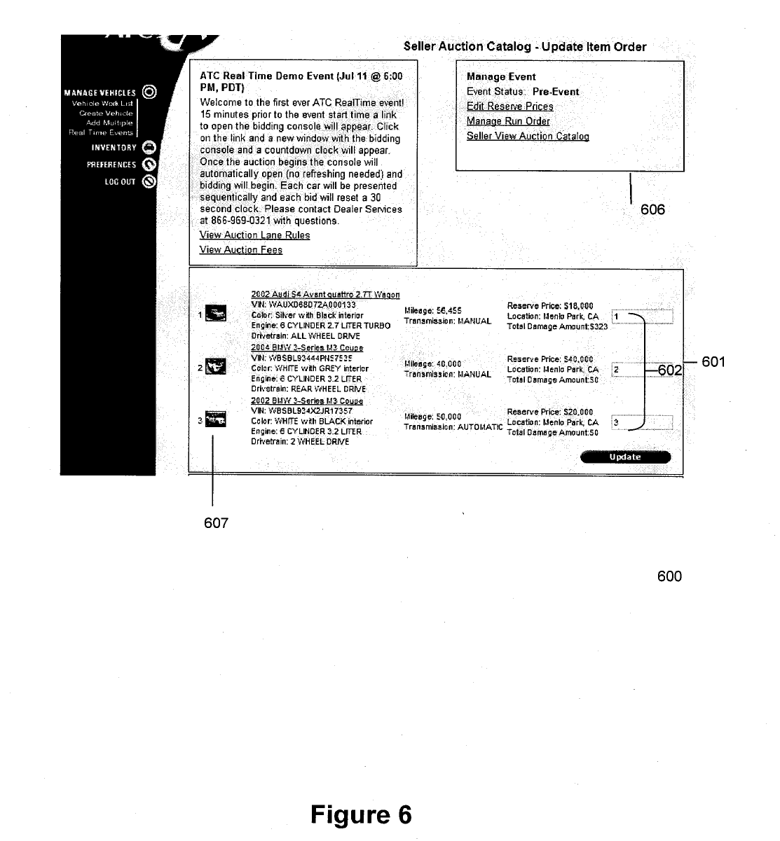

FIG. 6 shows a user interface for a seller for updating order of items in an auction catalog in a bidding tool, according to an embodiment of the invention. User interface 600 may include items such as a manage event window 606 and a list 601 of items for auction. List 601 of items for auction may include description of the respective items, such as VIN for vehicles, and may include other items such as images 607 of the respective items. An interface is provided to allow a user to change the order of the respective items. For example, here input boxes 602 allow user to control the order of the respective items, such as by numbering the items, according to one embodiment of the invention.

The system may display vehicles starting with the least desirable. According to an embodiment of the invention, next to each vehicle the system displays a box in which the user can set the order of the vehicles. For example, according to an embodiment, the system allows the user to input number 1 for the first vehicle, number 2 for the second vehicle and so on. The system updates the order of the vehicles in response to actions such as a click of an update button for the seller-user to save the new order.

The system provides a seller-user an interface that allows the seller-user to edit other information regarding vehicles in the event. For example, an embodiment of the system provides interface and associated logic that provides the seller-user the ability to update the pricing of items, such as vehicles, in an event. The system may provide a link to initiate such process, for example an interface in which the user clicks on a link associated with the event. The interface provides a catalog view of the vehicles that have been assigned to the event. A link or button may be provided to update vehicle pricing. In response to a click on such link or button, the system provides a interface, such as a web page, with a list of vehicles and an input, such as a box in which the user can set the reserve price of the item. The user may be able to tab between respective reserve price fields for respective items. Then in a response to a user input to save the changes, the system saves the changes to the prices.

The system displays information regarding the items in the catalog for the event. For example, the system displays for vehicles:
VIN,
Year, make, model, series, body style and/or other information,
Location (such as city and state),
Color (such as exterior and interior color),
Mileage,
Mechanical Attributes such as engine, drivetrain, transmission and/or other mechanical attributes,
Total damage amount from condition report,
Reserve price (which may have an input, such as a text box for setting the price).

According to an embodiment, the system may sort the list of items based on respective information associated with each item. For example, by selection of VIN, year, make, model and/or reserve price, the system may sort the list in accordance with the values of such items.

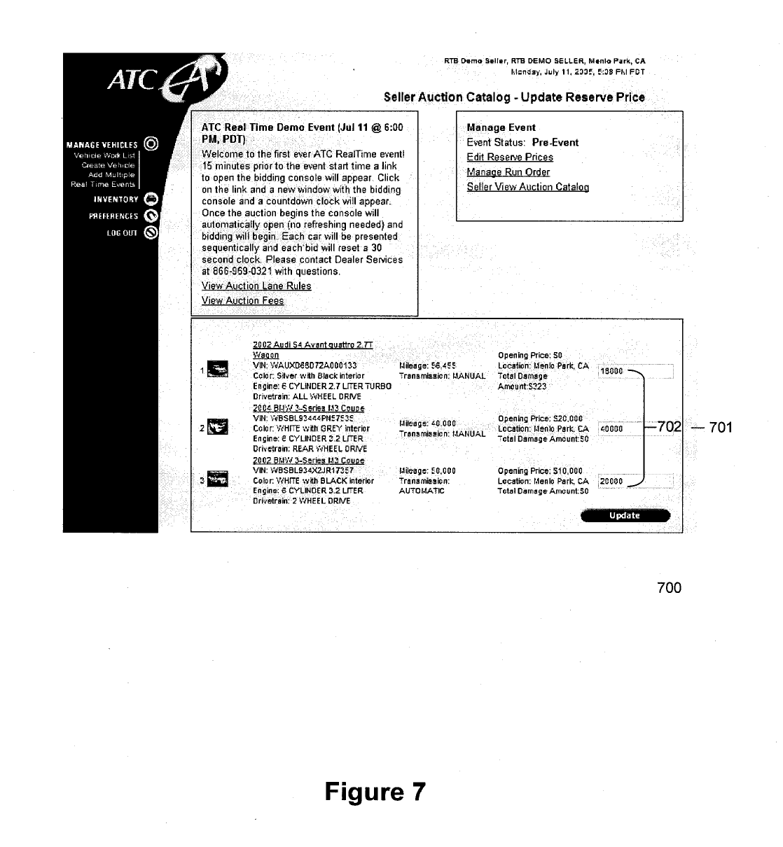

FIG. 7 shows a user interface for a seller for updating reserve price in an auction catalog in a bidding tool, according to an embodiment of the invention. An input 702 on interface 700 is provided to allow the user to set the respective reserve prices for items. Such input may be provided in the form of a box next to the respective items in the list 701 in which the user can type the price. Other methods of input and control of the reserve price are also possible, such as by pull-down menus or other user input or selection.

The system includes software that allows a seller-user to add vehicles to a bidding event. According to an embodiment of the invention, items, such as vehicles, are added to events differently depending on whether the items have already been added to the system (for example, and/or part of an existing work flow) or are added specifically for the event. If the seller has already loaded the vehicle into the system, the system allows seller-user to assign the vehicle to an event using an update life cycle function. For example, according to an embodiment, the system allows a user to update an event with adding a vehicle as follows:
The system allows a seller-user with appropriate permissions to manage vehicles to log into the system.
The system detects a user input on a “sell” link and opens a work page to allow the seller-user to add the vehicle. Such work page may be entitled, for example, “edit vehicle work page.”
The system prompts the user to enter a VIN in the work list for the vehicle that the user wanted to assign to the event.
The system shows the vehicle in the work list and provides an “edit” link to which the user can click. In response to such click, the system shows the user a vehicle work page. The system provides a button or a link for updating the status of the respective vehicle. This button or link may appear at the top of a page and a list of vehicle links that allow the user to change the status of the vehicle.
The system displays a page allowing the user to update the vehicle (this page may be titled “update life cycle”). The system displays on this page existing vehicle information as well as providing a pull down list with various events to which the vehicle may be assigned. If the vehicle is currently assigned to an existing event, the system displays the existing event assignment.
The system displays the option or otherwise prompts the user to designate an event to which to assign the vehicle. In response to the selection of the event, the system displays the respective new event associated with the vehicle on a user interface page associated with the vehicle. For example, the system may display the selected event in a current status section of an information box associated with the vehicle.
The system provides a link to events in a navigation interface and allows the user to select and display an event by selecting the appropriate button or link.
Upon user selection of the event, the system displays information about the event. For example, if the user has assigned a vehicle to the event and the user requests that the event be displayed, the event is displayed and the displayed event includes the vehicle that has been assigned to the event and the list of vehicles. Alternatively, if the user has removed a vehicle from the event, the list of vehicles for the event no longer includes the vehicle that has been removed.
According to an embodiment, if a vehicle does not have a reserve price when the vehicle is assigned to an event, the system lists the vehicle without a reserve price and allows the vehicle to be sold to the highest bid received during the auction.

According to an embodiment of the invention, a vehicle has a car group configuration assigned to the vehicle. This configuration governs post sale processes. According to another embodiment, if a vehicle has the status of not having been sold, the system keeps the “update life cycle” link active if the vehicle is relisted and otherwise does not keep the “update life cycle” link active.

According to an embodiment of the invention, if the system determines that there is no event in the future, the system will provide a indication of this to the user. For example, if no event having a start date after the time current is logged in the system, the system displays a message to the user. For example, the message may be displayed in red text and state that no events are active. The system may request that the user contact a system service manager to set up an event. A pull down list for events may indicate that no events are available, for example by displaying “none.”If a vehicle was not assigned to an event, a display associated with one vehicle may display an indication that the vehicle has not been assigned to an event, such as by displaying “none” in a field of the display in which events associated with the vehicle would normally be displayed. If a vehicle is assigned to an event and the seller changes the event assignment to no events, for example by changing the assignment to “none,” the system causes the vehicle to have the appropriate status, for example a status of “awaiting seller data.” According to an embodiment, if one or more events in the future exist for the seller, the system displays the events. The events may be displayed according to an embodiment of the invention in the pull down list, and the list may also include a “none” option by which the seller can elect to not assign the vehicle to an event. The system provides the user ability to select an event to which the vehicle be assigned and to submit the respective information.

As a vehicle is assigned to an event, the vehicle is added to the catalog for the event. According to an embodiment of the invention, the vehicles are placed in the catalog in the order in which the vehicles have been added, whereby the first vehicle assigned to the event appears at the top of the page.

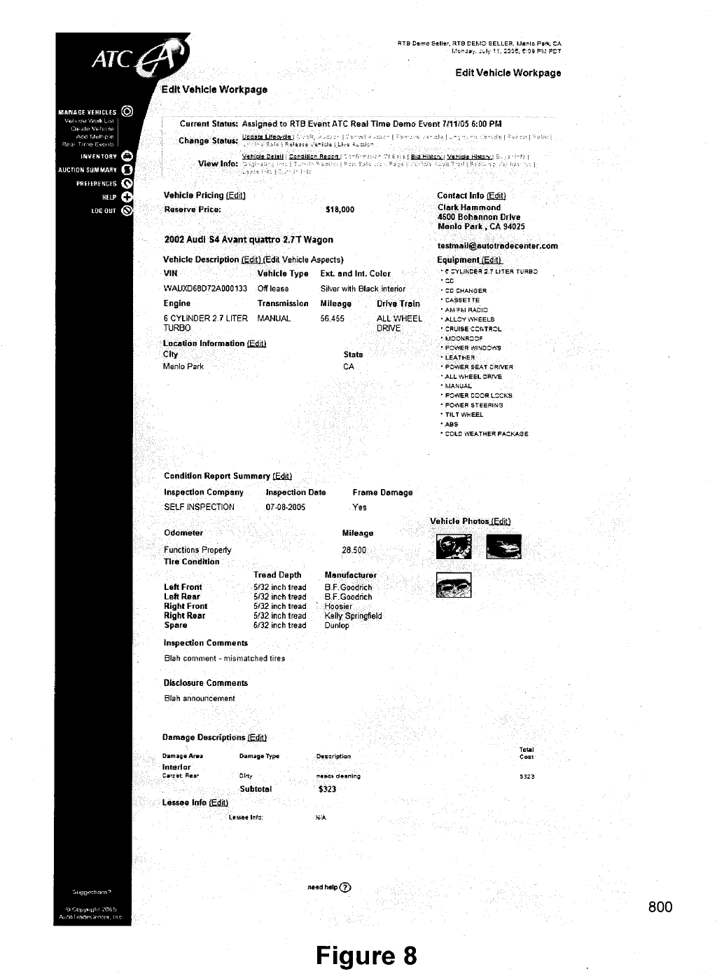

FIG. 8 shows a user interface for a seller for editing a vehicle work page in an auction catalog in a bidding tool, according to an embodiment of the invention. FIG. 8 includes generally a user interface 800. The work page may allow the user to change items such as the current status of the vehicle, pricing, and/or other aspects of the vehicle such as VIN, engine, location, equipment, condition report, odometer, tire condition, inspection comments, disclosure comments, damage descriptions, lessee information, and/or other information. Vehicle photos may be shown and an opportunity to upload photos may be provided through the work page, for example through the clicking of an edit link to an interface that allows for the photos to be edited and/or otherwise updated.

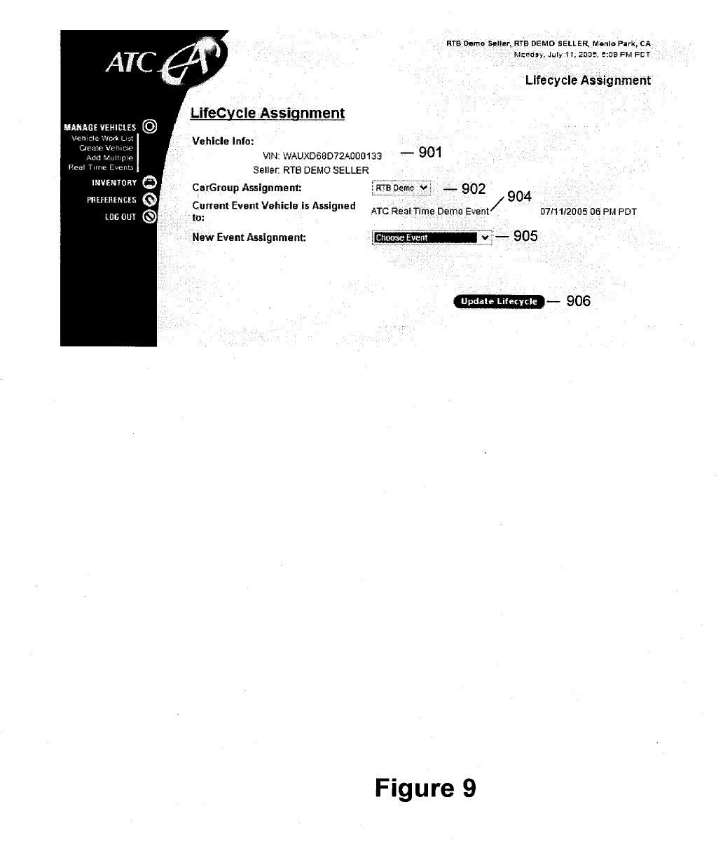

FIG. 9 shows a user interface for a seller for assigning lifecycle in a bidding tool, according to an embodiment of the invention. The interface may include information regarding the vehicle 901, a car group assignment 902, which may be editable, a current event to which the vehicle is assigned 904, and a new event assignment interface 905, according to an embodiment of the invention. The interface may include a button 906 to allow the user to update the life cycle after the user has made the appropriate selections.

After a vehicle has been assigned to an event, the system displays an “edit pricing” section of the work page for editing vehicle information in which only the reserve price can be set for the vehicle. According to an embodiment of the invention, the system sets the opening price for the vehicle in response to requests from administrative users who have permission to manage vehicles.

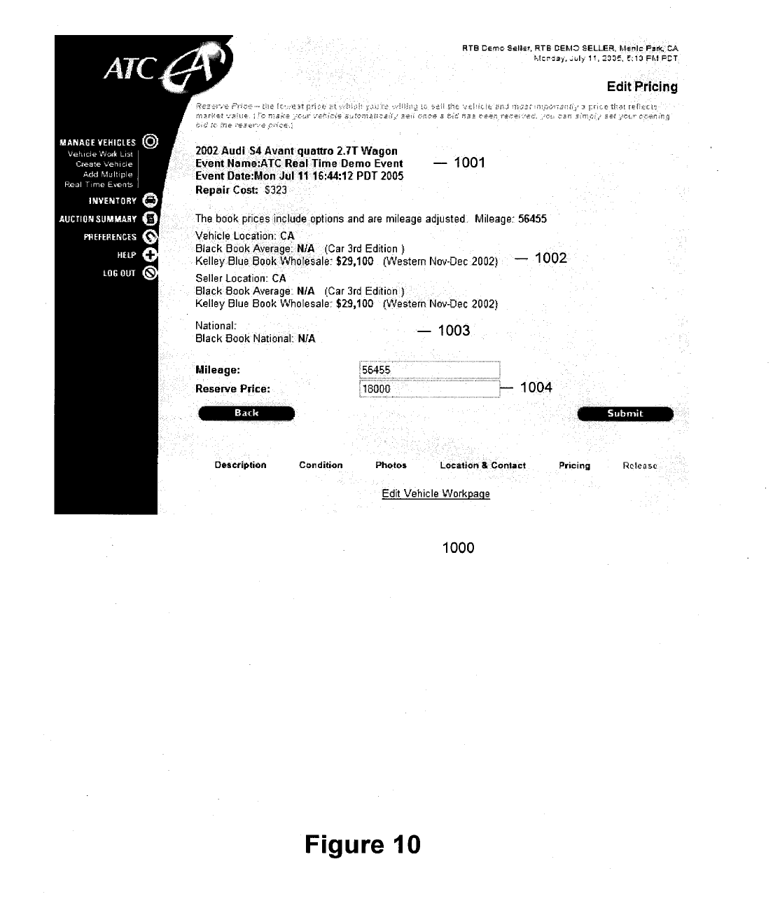

FIG. 10 shows a user interface for a seller for editing pricing in a bidding tool, according to an embodiment of the invention. Interface 1000 allows editing of pricing. Interface 1000 may include information 1001 regarding the vehicle, which identifies the type, year, event name, event date, repair costs and/or other information regarding the vehicle. Interface 1000 may also include information such as a standard price, such as a bluebook 1002 or blackbook 1003 price, or both or other combinations of standard prices or other price calculations. According to an embodiment, the user may refer to such prices in setting the reserve price of the vehicle. Also included is an input 1004 to allow the user to set the respective reserve price. According to one embodiment of the invention, the reserve price is automatically populated with a default value based on a standard price such as the bluebook or blackbook price, or some derivation of such price(s) such as a percentage of such standard price, or a percentage discount of such standard price. According to one embodiment, the user may accept or modify such automatically populated default value for the reserve price.

The system provides an interface by which the seller-user can upload pictures for the items to be sold. According to an embodiment, the system makes the images of vehicles that have been uploaded for a vehicle accessible within consoles for buyers and sellers, thereby displaying the respective images for vehicles. The system may allow a user to designate a picture as a primary picture for a vehicle, which the system will use as the first vehicle shown on the vehicle detailed page as well as within consoles for the buyers and sellers.

The system includes logic that allows a seller to create a representation of a new vehicle in a system. According to an embodiment, the system includes a process that walks the user through steps involved in creating (the representation of) a new vehicle. The system includes a user input, such as a button, allowing the user to request to create a new vehicle. The system includes input for information about the vehicle, such as the VIN. In response to selection of the appropriate interface input, such as a button, the system begins creating the vehicle with the respective VIN. The system may list the vehicle if the seller has a car group configuration for the vehicle or an event that includes the vehicle. When the system adds a new vehicle, the system receives information from the user to determine the life cycle of the vehicle. The system provides a page or other interface for the user to select a life cycle. Such selection may comprise the first step in the process of creating the new vehicle on the system. The system may allow the process of creating life cycle to be initiated through a button or a link, for example, in a status/info box which may be part of a work page to edit information about the vehicle.

According to an embodiment of the invention, if the seller organization has only one car group configuration, and no bidding events, then the vehicle is assigned to the car group configuration and the page to set the vehicle life cycle is bypassed. If the seller organization has more than one car group configuration, then, according to an embodiment, the system receives a selection from the user of which car group to which the vehicle is to be assigned. The car groups may appear on a pull down list. If the seller organization has one or more bidding events and no car group configurations, then an error may be presented. The error may indicate that a car group configuration should be set up for the vehicle before it can be loaded. Additionally, the system may ask the seller-user to contact the services manager to help resolve the issue. If the seller has one or more bidding events and one car group configuration, then the seller prompts the user to choose whether the vehicle belongs to a bidding event before proceeding. The system then sets the car group configuration automatically. If the seller has one or more bidding events and one or more car group configurations, the system allows the user to choose both the car group configuration for the vehicle and the bidding event.

The system receives opening price, reserve price, and buy price for the car group configurations and a reserve price for a bidding event listing.

The system includes functionality to allow a seller to manage inventory stored on the system. For example, the system may include functionality to allow the seller to search for and edit vehicle information by using a work list and/or vehicle editing work page. The system includes logic that allows the seller to edit the prices of vehicles. For example, the system may include a work page for editing vehicles in which the user has the button or link that caused the system to display an interface for editing the vehicle pricing. If the vehicle is assigned to a bidding event, the system allows the user to set the reserve price for the vehicle for the event. The respective event name and date displays on the interface, such as a price editing page associated with the event along with a price such as a black book or a blue book price for the respective item.

The system allows the user to manage and/or view images associated with the item to be sold. For example, according to an embodiment of the invention, the system displays pictures uploaded by user within the buyer and/or seller consoles. The pictures may be displayed as thumbnails which may be expanded by the user. The system allows the seller-user to select a primary picture for a respective vehicle. According to one embodiment, by default, the first image uploaded is set as primary picture.

An embodiment of the system includes an auction console for the seller such as auction console 303. According to an embodiment of the invention, if the event is farther in the future than a particular time period, the console is not available. For example, if the start time of the event is more than an hour before the current time, then the console is unavailable. If the event start time is within a particular time frame, for example, one hour from the current time, then the system makes the auction console available to the seller-user. Additionally, according to an embodiment, if the event has ended, the system does not make the console available.

As shown in FIG. 3, auction console 303 may include information regarding bidders 321 and bids 322 and an interface for modifying 333 the auction. Other information and actions may also be shown and/or allowed in auction console 303.

With respect to the number of bidders, the system may display a count of all buyers with active buyer consoles open or other count of buyers to indicate that buyers are active. The display of number of bidders may include number of bidders in a lane and/or number of unique bidders. The number of unique bidders may be measured as the count of all unique logins that have placed bids on a particular item (such as the bids on the particular vehicle). The number of bids may comprise a count of the total number of bids placed on the current vehicle. For example, if bidder A has placed three bids and bidder B has placed one bid, then a number of bids count of four would be reported.

Auction console 303 may include all of the following or various combinations of the following: sound for the start of an auction, sound for the end of an auction, sound for when bidding meets reserve price, sound for each vehicle sold, sound for each bid placed, and/or sounds for all bids having been placed. An embodiment of the system may include display on the console of the real-time display of bids as they are placed. The organization name of the bidder may also be displayed according to an embodiment. The system may include display of attributes of the respective vehicles or vehicle in the current auction, such as, in various combinations: VIN, year, make, model, series, mileage, odometer reading, exterior and interior color, engine, drivetrain, transmission, damage total, and/or location (city and state). The system may include a link to a detail page which opens in a new window according to an embodiment. The system may include a display of the following in the auction console: current high bid, current high bidder (including in an embodiment the organization name or the name of the buyer that has placed the current high bid), and/or list of all cars. The console may include a list of cars, on the bottom of the screen in a scrollable list of all upcoming vehicles, with attributes regarding the cars as discussed herein, for example, VIN, year, etc. The console may display the reserve price and/or a picture of the current car.

According to an embodiment, auction console 303 allows the seller-user to modify 333 the auction. The system may allow the seller to change the reserve price, such as through a button that allows the user to enter a custom reserve amount and submit it. The new reserve price may take effect immediately according to an embodiment. The bid clock may be reset if a new price is submitted according to an embodiment. Another embodiment of the auction console 303 additionally allows the seller to set the reserve price equal to the highest bid. In response to the user pushing the button, the system automatically sets the reserve price to the current highest bid, which price may be displayed in the button. The reserve price, once changed, is then indicated to the bidders.

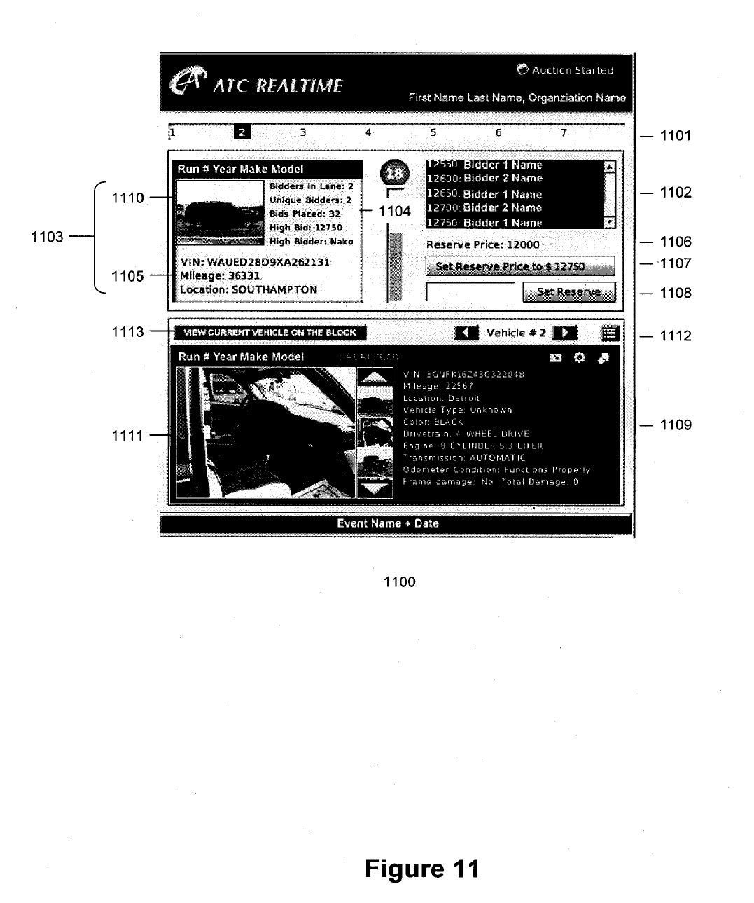

FIG. 11 shows an auction console interface for a seller in a bidding tool, according to an embodiment of the invention. FIG. 11 includes a console 1100. Console 1100 may include a display of progress through the event, which highlights the current item that is being auctioned, as shown here at 1101. In this example, item number 2 is currently being auctioned and is highlighted, and item 1 has already been the subject of bidding. Console 1100 may highlight a representation of the item being currently auctioned relative to other items in the action, for example along a line. Other items that will be auctioned later include items 3-7, shown to the right of item 2. Information may be shown in a window 1102 regarding the bids that have been made. This information may include the amounts of the bids and other information such as the name of the bidder who has made the respective bids. Other information regarding the vehicle and its attributes for the auction may be shown, for example, the reserve price shown at 1106, and detail regarding the currently auctioned item at 1103 and 1109. An input 1108 on interface 1100 is provided to allow the user to set the reserve price 1107 for an item in free text form, while an additional input 1107 may be provided to set the reserve price to a particular default value provided by the system, such as the current highest bid. This additional detail may include a profile of a particular vehicle as shown at 1103, which may include information regarding the bidding for such vehicle as shown at 1104 and information to identify the vehicle as shown at 1105. Images of the respective items to be auctioned may be included in the console, such as image 1110 and 1111. A particular portion of the console may allow a more detailed view of a particular item that is auctioned. For example, as shown here section 1109 contains detailed information regarding a particular item. This section may be changed to show other items for auction, such as with control buttons 1112. A button 1113 may be provided to view a particular item, such as viewing the current item that is being auctioned, as shown at 1113. By selecting the appropriate controls, the console may show information regarding the respective item in section 1109. Section 1103 may be used to show another item. For example, such section may be used to show the currently auctioned item by default.

According to an embodiment of the system, the system displays statistics regarding auctions, such as, in one implementation statistics regarding an event. After the conclusion of the event, the system may display statistics to the user. This display may take place in response to the user clicking on a link or button for display of statistics. The link may cause the console to close and open a display of event statistics which may follow the format of a catalog interface. According to an embodiment, the sales statistics may have a summary section including the various combinations of: number of vehicles run (listed in the event), number of vehicles sold, number of vehicles not sold, sale percentage (number of vehicles sold as compared to number of vehicles listed), number of bids placed, number of bidders (which may be measured as the number of buyers who opened a console), average bids per vehicle (for example, number of bids as compared to number of vehicles sold), total vehicle value (sum of all sale prices), total reserve value (total value of all reserves for sold vehicles), net gain above reserve (difference between end reserve and total reserve), and/or average compensation (for example, dollar sales) above reserve (net gain/total sold).

An embodiment of the invention includes a catalog from the event after the auction has occurred. Information may be included in a bottom section of a page shown to the seller-user with a list of all vehicles in the event. The following information may be displayed in each row: VIN; year, make, model, series, and body style; location (city, state); exterior and interior color; mileage; engine, drivetrain, and transmission; total damage report from condition report; reserve price; sale price, status (sold or not sold); and/or link to a work page to edit the vehicle.

According to an embodiment of the invention, the system includes software to send a notification email to a seller. The notification email may include information regarding a vehicle sold. For example, the email may include a subject line that a vehicle has been sold in real-time with information identifying the vehicle (such as the VIN number). The email may include other identification regarding the vehicle that was sold during the event, and an identification of the event. The identification information may include various forms of information in various combinations as discussed herein, such as VIN, color, and/or miles. Additional information regarding the sale may be included such as reserve price, sales price, transport cost, transport and setup, total transport costs (transport price minus transport incentive amount), buy fee, payment processing fee, total price (vehicle price+transport price−(transport incentive amount+buy fee+payment processing fee)), payment method, transport method, sale fee, listing fee, purchasing user, purchasing dealer name, purchasing dealer number, purchasing dealer phone and/or purchasing dealer fax number.

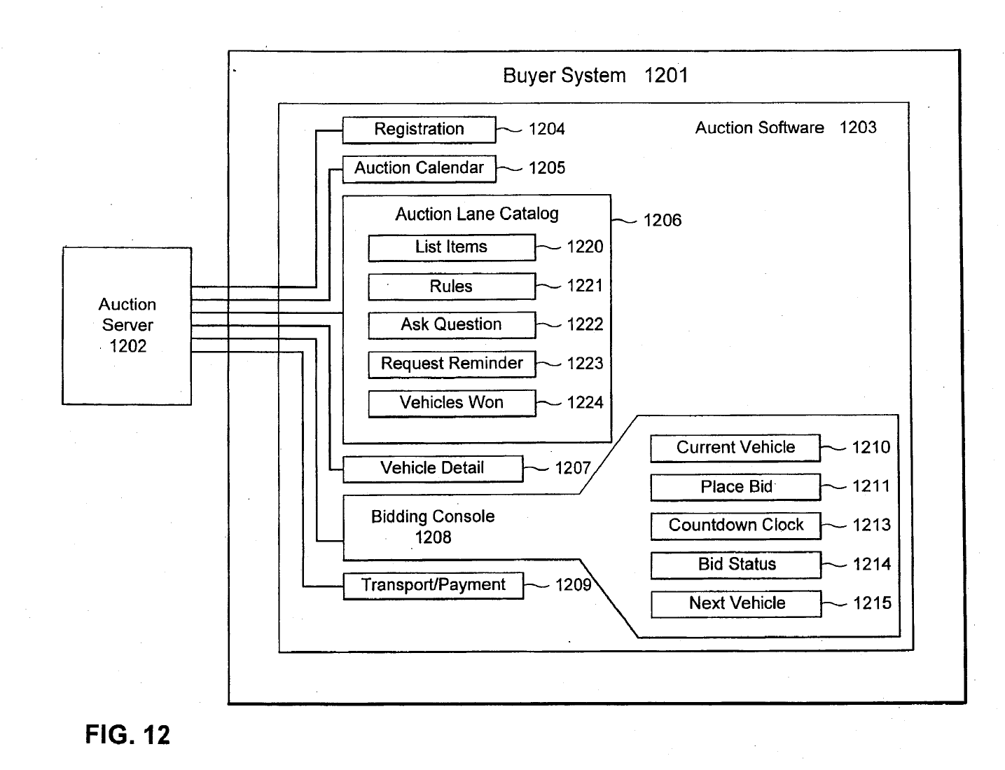

FIG. 12 is a block diagram of a buyer system of a bidding tool, according to an embodiment of the invention. Shown is buyer system 1201, which is coupled to auction server 1202. Buyer system 1201 includes various components of an electronic or computer system such as a processor, display, and storage. Additionally, buyer system 1201 includes auction software 1203. Auction software 1203 includes registration logic 1204, auction calendar 1205, auction lane catalog 1206, vehicle detail logic 1207, bidding console 1208, and transport/payment logic 1209.

These various logical blocks of auction software 1203 may be implemented in software, hardware, or combination of both, and additionally may be implemented in software, hardware or other logic located on buyer system 1201, auction server 1202, or located in both buyer system 1201 and auction server 1202. According to one embodiment, much of the control of auction software 1203 is provided by software located on auction server 1202, which may include a web server and serve web pages corresponding to the various logical blocks shown in auction software 1203, resulting in corresponding aspects of the user interface to be displayed on buyer system 1201.

Additionally, all or some of the various logical blocks of auction software 1203 display, use, and/or modify information on or from auction server 1202. For example, registration logic 1204 stores information about the respective buyer user on auction server 1202; auction calendar 1205 receives a calendar of auction events from auction server 1202; auction lane catalog 1206 receives information about respective auction lane from auction server 1202; vehicle detail logic 1207 receives information about respective items to be sold from auction server 1202; bidding console 1208 receives information regarding the auctions from auction server 1202 and interacts with auction server 1202 to allow the buyer to participate in the auctions; and transport/payment logic 1209 interacts with auction server 1202 to provide transport and payment options for the buyer user.

Auction lane catalog 1206 includes functionality for listing items 1220, indicating rules 1221, asking seller a question 1222, requesting a reminder 1223, and displaying vehicles won 1224. The bidding console has various functions to allow the buyer/user to participate in bidding; for example, logic to display the current vehicle 1210, logic to place a bid 1211, a count down clock 1213, bid status 1214, and the next vehicle 1215.

The auction calendar displays a list of available auction lanes to the buyer user. Multiple sellers may appear within a buyer's auction calendar to the extent that the buyer has been given access to participate in the auction lane. The list of available auction lanes may be ordered by date, with the most recent date at the top of the list. According to one embodiment, by default the auction lanes are sorted by date with the most recent auction lanes on top.

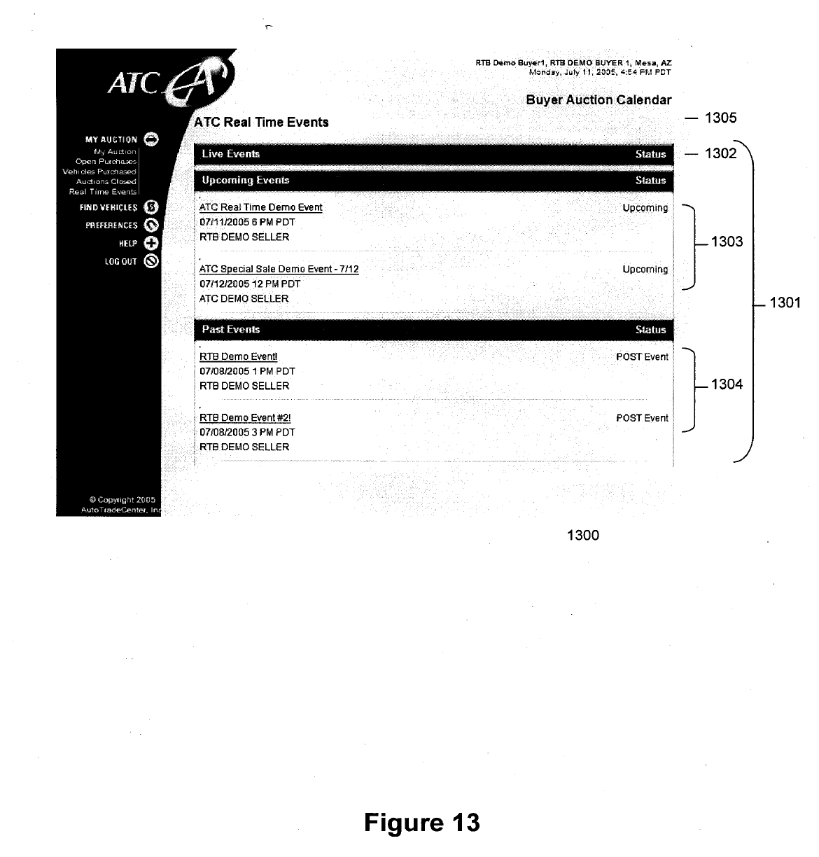

FIG. 13 shows a user interface for a buyer showing an auction calendar in a bidding tool, according to an embodiment of the invention. The interface is shown generally at 1300. The interface may include a calendar 1301 of events. Calendar 1301 may include a listing of live events 1302, upcoming events 1303, and past events 1304. Information regarding the respective events may be included in an arrangement such as in columns. For example, as shown in FIG. 13, status 1305 is shown for respective events. The listing of events may include clickable links that allow the user to obtain more information, participate in the event or otherwise interact with the system regarding the particular event.

According to an embodiment, the auction calendar may include the following for each auction lane: the name of the auction lane, the date and time of the auction lane, the seller who is selling the items (vehicles), and current status of the auction lane. According to an embodiment, the name may include a clickable link that takes the buyer/user to a display of the catalog for the auction lane. The current status may include current bidding, closed, or upcoming. According to an embodiment, the current status is dynamic and change is based on the current status of the auction lane. If the status is currently bidding, the system may include an indication such as “bid now!” to the user on buyer system 1201. According to an embodiment, the status of current bidding may begin fifteen minutes or some other particular time period before start of the event or if the event is currently running. The indication that the bidding is currently taking place may include a clickable link that takes the user to the event. Alternatively this indication may be provided by an icon. The system may prompt a user for default payment and/or transport options before the system provides an interface, such as bidding console 1208, that allows the user to bid in the event. An embodiment of the system retains the options set by user and allows the user to re-use those options. For example, the system may open a bidding console after the options have been set, and, if the user accidentally closes a console and returns to the console later, the previously set options are retained.

The system may include logic to display a closed status if the auction has closed. This status may be provided if the auction has closed within some particular time period, such as the last 24 hours according to an embodiment. According to an embodiment, the indication of closed status may include a clickable link that causes the system to display the auction lane catalog when it receives an indication that the user has clicked. The auction lane may no longer appear on the auction calendar after a particular time, such as after 24 hours have passed.

An embodiment of the system includes logic that causes the auction calendar to be sorted upon receipt of a request from the user. The system may sort the page by any of the column headers in the auction calendar. Secondary sort criteria may be by date, with the newest dates listed first in order to provide a calendar format. Other sort criteria used may include various combinations of name (sorted A to Z or Z to A), date, seller (for example by alphabetical order), and/or current status. When sorted by current status, the sorting may include sorting by whether the events are closed, currently bidding, and upcoming. The order may be reversed, for example as upcoming, closed, and currently bidding. According to one embodiment of the system, the system successively reverts from between these two orders when the user successively selects the sorting according to current status.

An embodiment of the invention includes logic to display an auction lane catalog 1206 on buyer system 1201. Auction lane catalog 1206 includes an indication of rules of the auction lane, view of the vehicles available for sale 1220, allowing the seller to ask a question 1222 about auction lane, and functionality to configure a reminder 1223 to be sent to someone prior to the start of the event. The auction lane catalog page can be dynamically updated based on the status of the auction lane event. For example, a feature may be enabled during the pre-bidding phase but disabled once the auction lane event begins. Various statuses may include pre-event, live event, and post event.

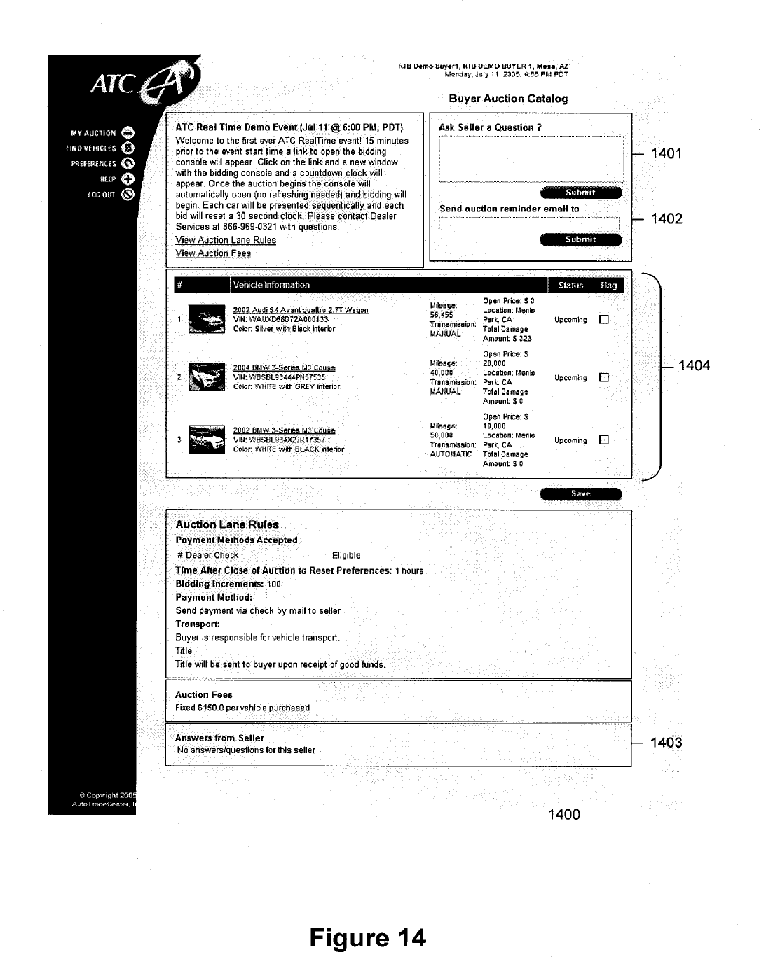

FIG. 14 shows a user interface for a buyer showing an auction catalog in a bidding tool, according to an embodiment of the invention. Auction catalog interface 1400 may include display of items similar to those shown in a seller catalog. According to an embodiment, interface 1400 may include dialogue boxes for tasks such as asking the seller a question 1401, requesting a reminder email regarding the auction 1402, and displaying answers to questions from a seller 1403. Vehicles are listed, as shown at 1404. The order of the listing is the order that the seller has set for such items, according to an embodiment of the invention.

The listing of vehicles that will be auctioned during a live event is displayed on buyer system 1201, according to an embodiment, and will include items (vehicles) displayed in the order set by the seller. Information displayed identifies the items to be sold and provides information about these items, such as, in the case of vehicles: order number; VIN; year, make, model, series, body style (this may include a clickable link which will take the user to a vehicle detail page); location (city, state); mileage; and/or opening price. According to an embodiment, the system makes the full run list visible prior to event (for example during a particular pre-event time) and during the event. After the event, the system displays only vehicles purchased by the buyer.

The system includes functionality to display auction rules 1221. Rules may include the following and various combinations of the following: whether absentee bidding is allowed; buy fee structure; payment methods that are accepted (the system displays next to the respective payment methods whether or not the buyer is eligible, for example, the fast lane: eligible; wire transfer: not eligible); transport options; settlement information; time after close of auction to reset preferences; and/or bidding increments. The system may make the auction rules visible during all stages of the auction lane event according to an embodiment.

The system includes logic to prompt the user to submit a question to the seller, such as through ask question function 1222. The feature may give the buyer the ability to ask the seller a question relating to a subject relative to the auction lane event as a whole. According to an embodiment, the buyer may ask the seller the question relating to a specific vehicle. According to another embodiment, the buyer may not ask the seller the question relating to a specific vehicle. According to an embodiment, if the seller responds to the buyer's question, then both the buyer's question and seller's answer are displayed on the auction lane catalog. According to an embodiment, any question that has been asked and answered may be displayed to any user who can view the auction lane catalog. If a question is asked, but not answered, then the question may not be displayed according to an embodiment. According to an embodiment, the identity of the buyer who asked the question is not displayed.

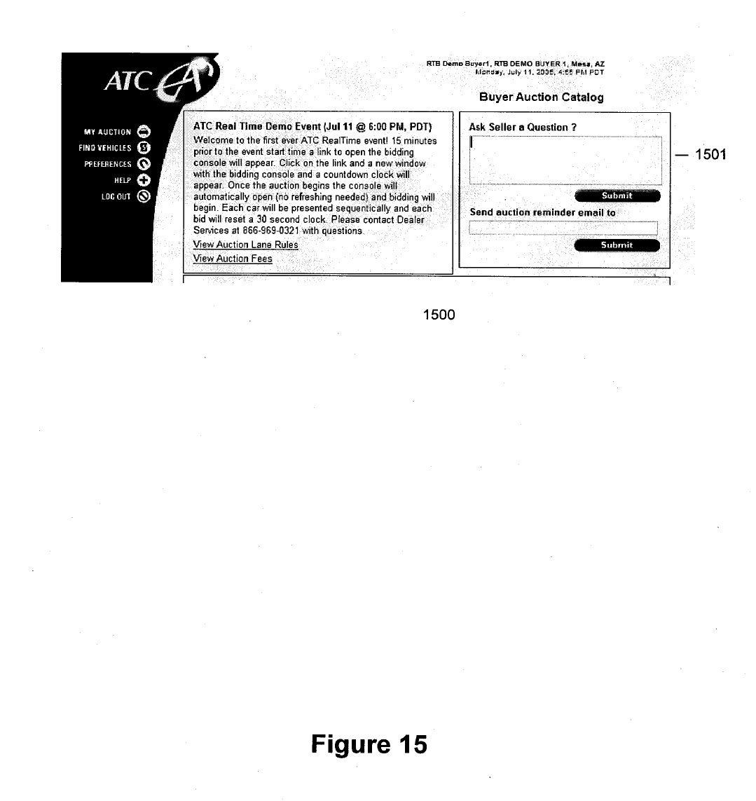

FIG. 15 shows a user interface for a buyer with a question input in a bidding tool, according to an embodiment of the invention. The interface 1500 includes an input 1501 in which the seller can ask the buyer a question. The interface may include an input for free form of text input for the question. Alternatively, other forms of input for a question may be provided. For example, a pull-down menu may be provided with a list of questions that the buyer may ask. Other forms of input are also possible to allow the buyer to ask a question or obtain additional information from the seller.

The question feature may be enabled and visible during pre-event phase. During a live event phase, the question feature may be disabled or hidden, but questions and answers may be visible according to an embodiment, and during a post-event phase the question feature may be disabled and/or hidden but the questions and answers may be visible.

An embodiment of the system allows the buyer/user to request a notification to be sent regarding an event. For example, request/reminder function 1223 of auction lane catalog 1206 allows a user to enter an address (such as an email address) where the notification will be sent regarding the auction lane event. By default, the text box for the address may be populated with the user's email on file. The system may provide the user the ability to modify the email address in the text box. According to an embodiment, the system sends reminders 24 hours before the start of an event and one hour before the start of the event, or in other selected intervals. The system may include a validation to prevent user from submitting an invalid address that is missing, for example the “@” and may require the address to have at least one character before the “@” sign and have a period followed by at least two characters after the “@.” If the event begins in less than 24 hours, then the reminder that would normally be sent at 24 hours before the event may be sent as soon as possible. If the event date has changed after a reminder has already been sent, the reminder may be resent according to the new event time. For example, events may be scheduled at 1:00 PM on Wednesday. By 12:00 PM on Wednesday, the user may have already received the 24 hour and one hour reminders. At 12:30 PM the event may be postponed until Friday at 1:00 PM. The user now receives another 24 hour reminder on Thursday at 1:00 PM and another one hour reminder at 12:00 PM on Friday.

The system includes functionality to show vehicles won, such as the vehicles won functionality 1224 of auction lane catalog 1206. At the conclusion of the event (post event phase) the user can no longer see the full run list of vehicles according to an embodiment. During this phase the user sees the vehicles for which the user was the high bidder and the reserve price was met (the vehicles that the user has won). The user may have the opportunity to modify payment and transfer options on a vehicle based on a particular time after close of auction to reset preferences, which time may be set by the administrator or seller. Once this period expires, the buyer may not be able to make any modifications. The following fields may be displayed into various combinations: VIN; year, make, model, series, bodystyle; location of vehicle (city, state); winning bid amount; payment method option; payment method fee; transport option; transport option fee; taxes; and/or total.

As to the payment method option, after the time after close of auction to reset preferences expires, the user is not allowed to modify the payment method option according to an embodiment. Fixed text which displays the options selected by the buyer is displayed according to an embodiment, and a drop down box is no longer visible according to an embodiment.

With respect to the payment method fee, the fee amount may be displayed dynamically based on the selected payment option. Alternatively the fee may be displayed once the user has selected the save button or the fee can be displayed directly within a drop down box.

With respect to the transport option once the time after close of auction to reset preferences expires, the user is not allowed to modify the transport option according to an embodiment. Fixed text displays the options selected by the buyer. A drop down box is no longer visible for this option.

With respect to the option fee, the fee amount is displayed dynamically based on the selected transport option. Alternatively, the fee displayed once the user has selected the save button or the fee can be displayed directly within the drop down box.

With respect to taxes, according to an embodiment taxes are calculated (including taxes on the transport option) and displayed dynamically based on the selected payment option. Alternatively this is displayed once the user has selected the save button.

With respect to the total, total amount may be calculated and displayed dynamically based on the settlement options selected as well as taxes. Alternatively the total may be displayed once the user has selected the save button.

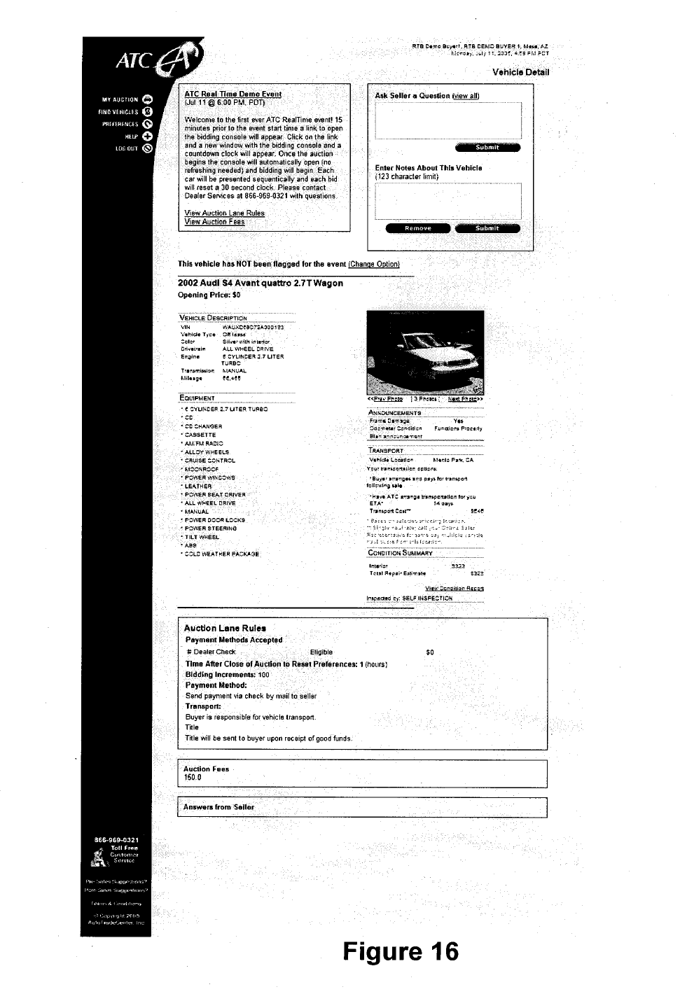

FIG. 16 shows a user interface for a buyer showing item detail in a bidding tool, according to an embodiment of the invention. Buyer system 1201 may include logic to display vehicle detail, such as vehicle detail logic 1207. Vehicle detail may be displayed as a vehicle detail page. The detail may include opening price, vehicle condition report, vehicle pictures, notes, flag car for live event, and/or an option to ask the seller a question. With respect to the vehicle condition report, if third party inspection has been performed and is present on the vehicle, the inspection may be visible to all buyers participating in an auction lane event according to an embodiment in the invention. The vehicle pictures may include any pictures available for the vehicle or a subset of the pictures that have been provided for the vehicle according to various embodiments in the invention. Notes is a section of the interface that accepts notes from a buyer into the vehicle detail page, where the buyer can enter and save notes about the vehicle. Text entered in this section appears in the notes section of bidding console 1208. If a user saves notes for the vehicle, the vehicle may be automatically flagged. If it is pre-event, the notes feature is enabled and notes are visible. If the system is in the live event phase, the notes editing is disabled or hidden and saved notes are visible. If the system is in the post event phase, the editing of the notes is disabled or hidden and the saved notes regarding the event are visible.

Flagging a car for a live event is available through the vehicle detail page. The user is able to flag a car for the live event. If a user flags a car, the car is uniquely denoted on the bidding console for the user. The user has the ability to change the option by selecting a link which refreshes the page. The updated page then shows the vehicle has been flagged. If the user selects the link again to change the option, the page refreshes and indicates that the vehicle has not been flagged.

A functionality to ask a seller a question is provided according to an embodiment of the invention, and this function may be provided as part of vehicle detail 1207. This feature provides the buyer the ability to ask the seller a question relating to the vehicle. According to an embodiment, this feature is used not to ask the seller a question regarding the general auction (such as payment method, etc.). If the seller responds to a buyer's question, then both the buyer's question and the seller's answer is displayed on the vehicle detail page. According to an embodiment, any question that has been asked and answered is visible to all buyers participating in the event. If a question is asked, but not answered, the question may not be displayed according to an embodiment. For questions asked and answered, the buyer's identity that asked the question is not displayed according to an embodiment. According to an embodiment in the invention, this feature of question asking and answering may be available with respect to various phases as shown below:

Pre-Event
Ask seller a question feature is enabled/visible,
Questions and answers are visible.

Live-Event
Ask seller a question feature is disabled/hidden,
Questions and answers are visible.

Post-Event
Ask seller a question feature is disabled/hidden,
Questions and answers are visible.

A bidding console, such as bidding console 1208 is provided in buyer system 1201. The bidding console allows buyers to place bids during the live auction lane event. The bidding console may include various features such as the following: sound, preferences, and/or features/display.

With respect to the sounds, according to an embodiment, each time a bid is placed on a vehicle the system produces a sound associated with the bidding console. When the current bidding has met the reserve price, or if the seller has placed the vehicle on the market, the system produces a sound.

With respect to the preferences, prior to the buyer launching the bidding console, the system prompts the user to select the preferred payment method and transport options from the auction calendar page. The system saves the selections made on the screen and displays the selections on the auction lane catalog at the completion of the event.

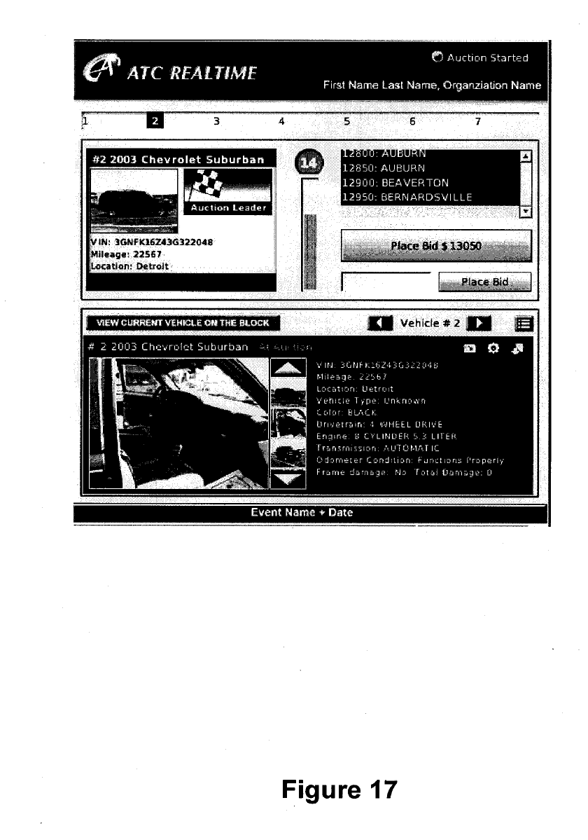

FIG. 17 shows an auction console interface for a buyer in a bidding tool, according to an embodiment of the invention. According to various embodiments of the invention the bidding console may include the following features and/or display items in various combinations:
Current vehicle (run#, year, make, model, location (city, state) may be displayed for the current vehicle at auction.),
Current Vehicle Details (the bidding console may have an area that displays the following additional information about the current vehicle at auction: VIN (the VIN is displayed in a way that would allow the user to copy and paste this into another application), transmission, mileage, interior color, exterior color, frame damage, odometer replacement/tampering, and/or link to full vehicle detail page.) (With respect to a link to full detail page, this may be implemented as following according to an embodiment of the invention. If a user selects this link, a browser window spawns which contains the vehicle detail page for the current vehicle at auction. The browser window does not have to dynamically update based on the current vehicle at auction. However, subsequent clicks on the link to view the full vehicle detail page should open the information in the same window. A new browser window may not be spawned each time the link to view the full vehicle detail page is selected, according to an embodiment.),
Current Vehicle Notes (The bidding console has an area that displays any notes the buyer has entered during the pre-event phase for the specific vehicle.),
Current Vehicle Announcements (The bidding console has an area that displays any vehicle announcements entered by the seller.),
Current Vehicle Condition Report (If present, inspection information will be accessible in the bidding console.),
Current Vehicle Main Photo (A large picture of the vehicle currently up for auction may be displayed.),
Current Vehicle Thumbnails (User is able to view additional photos as thumbnails. Clicking on a thumbnail will enlarge the picture.),
Countdown Clock (Based on a “countdown” setting for the auction lane, the countdown clock displays the amount of time left available to place bids for the vehicle. The amount of time left may be displayed graphically as well as in text.),
Buyer's Bid Status (Information about the buyer's current bid status is displayed.)
   Place Your Bid Now: Buyer has not yet placed a bid,
   Auction Leader: The buyer currently has the current high bid,
   Trailing Auction: The buyer has previously placed a bid, but has been outbid,
   Auction Ended - You Won: The buyer had the high bid when the auction for the vehicle ended,
   Auction Ended - Did not Win: The buyer placed a bid for the vehicle, but did not have the high bid when the auction ended,
   Auction Ended: The auction has ended and the buyer did not place any bids for the vehicle.
Current Vehicle's Reserve Status (If bidding has met or exceeded the seller's reserve price for the vehicle, a notification is displayed within the bidding console. If bidding has not yet met the seller's reserve price, then no message is provided.),
Bids Placed for Current Vehicle (Each unique bid placed for the vehicle is displayed on the bidding console.) The system does not display the identity of the bidder that placed the bid. However, the bid amount and the location of the bidder can be displayed.

Minimum Bid Button (The user can enter the minimum bid amount by clicking a button. The minimum bid amount should be updated based on the current high bid.) For example, with respect to the minimum bid button the system may implement the following:
1. During an auction, the current high bid amount is $10,000
2. Bid increments are set to $100
3. The Minimum Bid Button displays “Bid $10,100”
4. Bidder1 clicks the Minimum Bid button
5. The Minimum Bid Button now displays “Bid $10,200”
6. Bidder1 clicks the Minimum Bid button again
7. The Minimum Bid Button now displays “Bid $10,300”
   Manually Entered Bid (The system allows the user to place a bid higher than the minimum bid amount by manually entering and submitting the bid. A bid entered manually is treated as a hard bid. If the user enters a bid that is equal to or greater than twice the amount of the current high bid, the Bidding Console forces the user to confirm his bid. A manually entered bid can be made in an allowable increment. If a user has the current high bid and attempts to manually submit a bid, the Bidding Console forces the user to confirm his bid.) The following is an example of the manually entered bid:
1. During an auction, the current high bid amount is $10,000
2. Bid increments are set to $100
3. A user enters $9,000 and clicks the submit button
4. The system rejects the bid
5. The user receives an error message “Your bid is too low”

Another example of the use of a manually entered bid is as follows:
1. During an auction, the current high bid amount is $10,000
2. Bid increments are set to $100
3. A user enters $11,111 and clicks the submit button
4. The system rejects the bid
5. The user receives an pop-up message “Bids must be placed in $100 increments”

Another example of the use of a manually entered bid is as follows:
1. During an auction, the current high bid amount is $10,000
2. Bid increments are set to $100
3. Bidder1 enters a bid of $25,000 and clicks the submit button
4. Bidder1 receives a pop-up message “You have entered a bid that is more than twice the current minimum bid amount. Are you sure you want to place this bid?”
5. Bidder1 clicks “Yes”
6. The current high bid amount is $25,000
7. Bidder1 enters a bid of $30,000 and clicks the submit button
8. Bidder1 receives a pop-up message “You already have the current high bid.
   Are you sure you want to want to place another bid?”
9. Bidder1 clicks “No”
10. The bid is not placed. The current high bid amount is $25,000
   Next Vehicles In Run List (The bidding console displays the next 2 vehicles in the event run list. Information on the next few vehicles may include the following: vehicle image, year, make, model, series; VIN; mileage, transmission, interior color, exterior color, link to full vehicle detail page.) (If user selects this link according to an embodiment, a browser window spawns which contains the vehicle detail page for the current vehicle at auction. The browser window does not have to dynamically update based on the current vehicle at auction. However, subsequent clicks on the link to view the full vehicle detail page opens the information in the same window. A new browser window may not be spawned each time the link to view the Full Vehicle Detail Page is selected.)
   Flagged Vehicles (For any vehicles flagged by a user, the vehicle should be denoted accordingly within the bidding console.)

According to an embodiment of the invention, buyer system 1201 provides a buyer report. The buyer report may comprise a purchase report which includes vehicles purchased through the auction server.

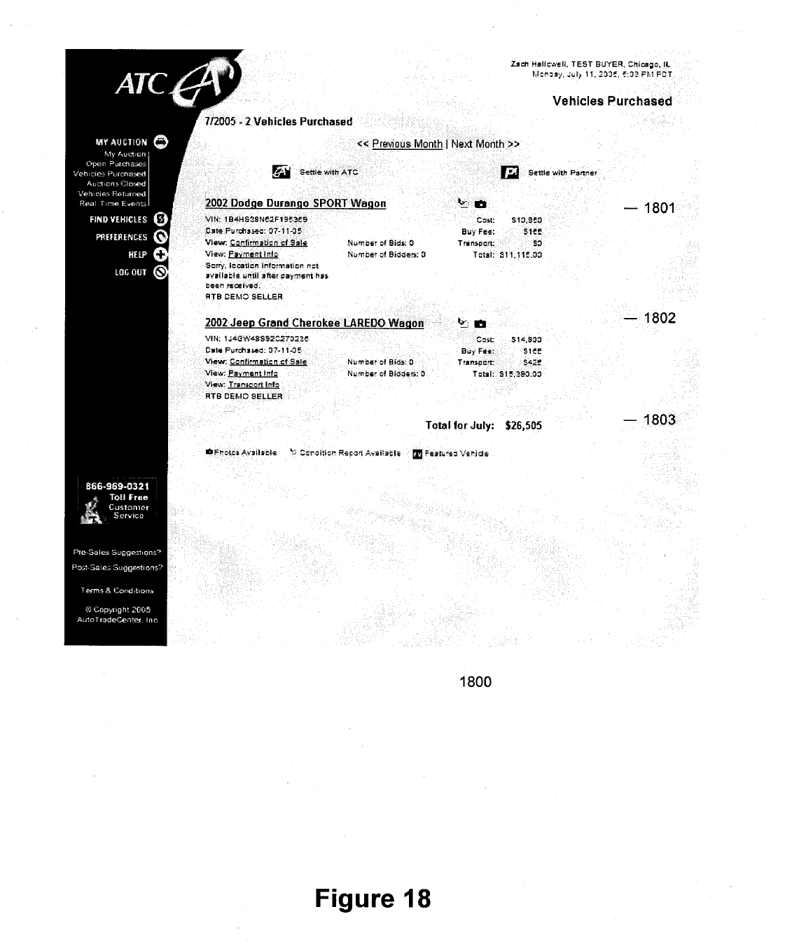

FIG. 18 shows a user interface for a buyer showing items purchased in a bidding tool, according to an embodiment of the invention. Such interface may be an example of a buyer report. The report 1800 may include information regarding various vehicles, as shown here vehicles 1801 and 1802. The detail may include information such as the cost, buying fee, transport fee, total cost, date purchased, VIN and/or other information, or a subset of such information. Clickable links or buttons may allow the user to obtain other information regarding the respective items. For example, the user may click a button to show a confirmation of the sale, payment information, and/or transferred information. A summary of the total amount of money for a purchase may be provided as shown at 1803.

The system may include functionality to send a notification message to the buyer regarding vehicle(s) purchased. The notification message may comprise an email with a subject line with the identification of the vehicle (such by VIN). The email may include information such as the following, in various combinations: VIN, color, mileage, sales price, transport cost, transport incentive, total transport cost (transport price minus transport incentive amount), buy fee amount, payment processing fee, total price (vehicle price plus transport price−((transport incentive amount+buy fee plus payment processing fee)), payment method, transport method, seller name, payment description, and/or transport description.

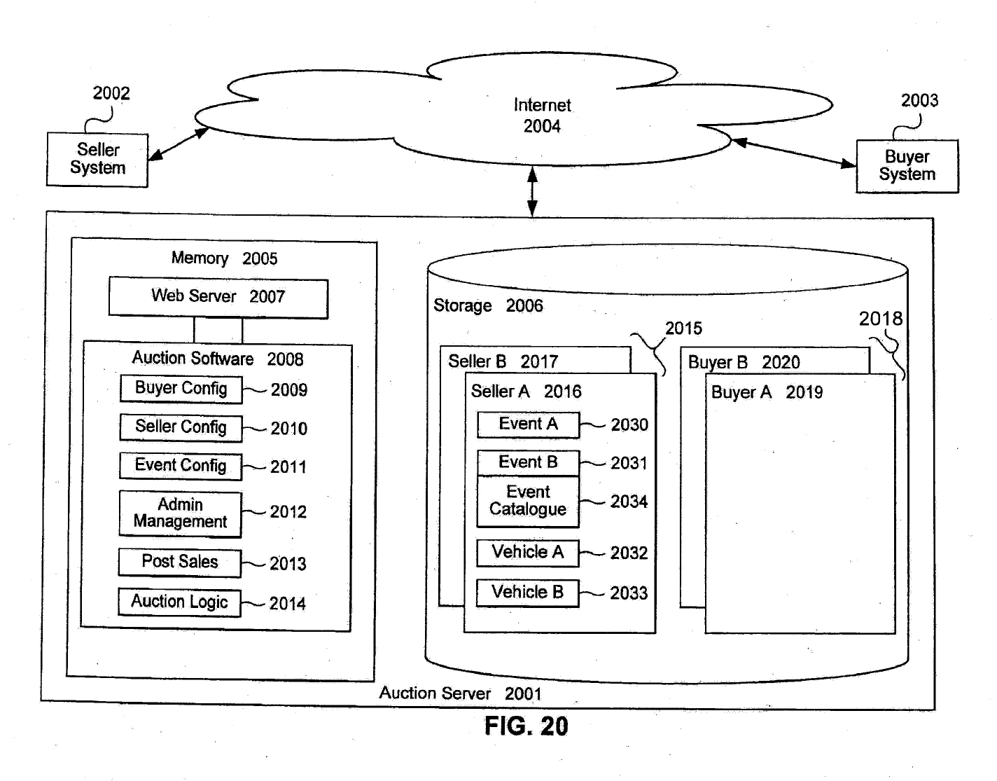

FIG. 20 is a block diagram of an auction server of a bidding tool, according to an embodiment of the invention. Shown is auction server 2001, which is coupled to seller system 2002 and buyer system 2003 through Internet 2004. Auction server 2001 includes memory 2005 and storage 2006. Memory may load software that is run by auction server 2001 such as web server 2007 and auction software 2008. Auction software includes administrative features and auction logic. Various components of auction software include buyer configuration 2009, seller configuration 2010, event configuration 2011, administration management 2012, post sales logic 2013, and auction logic 2014.

Storage 2006 includes storage of information used for administration and auctions. Note that storage 2006 may be stored in various forms of storage and memories as described herein, and may be distributed through different forms of memory and/or different databases and storage devices. As shown, storage 2006 includes seller information 2015 and buyer information 2018. Seller information 2015 includes records regarding various sellers. As shown here, seller information 2015 includes information regarding seller A 2016 and information regarding the seller B 2017.

Information regarding a seller may include information for administration of the seller's account and information regarding events (e.g., event A 2030 and event B 2031) and inventory (e.g., vehicle A 2032 and vehicle B 2033) possessed by the seller. Events may include detailed information regarding the events such as information stored in event catalog 2034. Records may be stored for buyers, as shown with buyer records 2018, which include buyer record A 2019 and buyer record B 2020.

Administration of auction server 2001 and related functions regarding auctions managed in auction server 2001 may be provided automatically or by system administrators interacting with administration software, or through a combination of such approaches. Through interaction with such automatic features or system administrators, the seller and the service provider can determine when the auction should occur and various parameters that will be set. According to an embodiment, the administrator of the system then sets up the auction and notifies the seller that the event is ready for the seller to begin associating items (e.g., vehicles) with the event. Additionally, the system may allow the seller-user to perform functions otherwise performed by an administrator, such as creating events. The ability to perform such functions may involve granting the seller a special permission. According to an embodiment, no updates (beyond marking the auction inactive) are allowed at some particular time (e.g., 5 minutes) before the event and through the end of the event in some configurations. Users may be assigned appropriate permissions in order to administer the system.

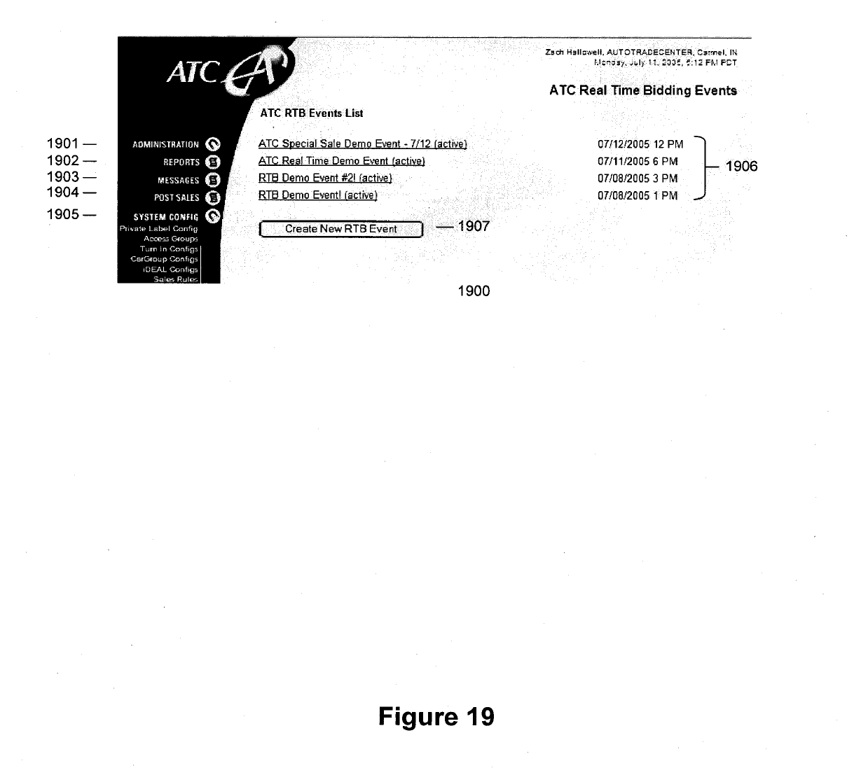

FIG. 19 shows a user interface for an administrator in a bidding tool, according to an embodiment of the invention. Shown are interface 1900 generally which may include blanks or buttons to control or participate in administration 1901, reports 1902, messages 1903, post-sales 1904 and/or system configuration 1905. The interface may include other information such as a list 1906 of events. A button or other input to create new events may be provided as shown at 1907. Other forms of inputs and interfaces may be provided for the administrator of the system.

Software in auction server 2001 includes event configuration logic 2011, which allows for configuring events. The software may provide an appropriate link to real-time bidding events under a system configuration navigation button. On the events page, existing events may be listed and a link to create a new event may be displayed. The list may include name and date of the event and may be ordered by the date of the sale, with the newest events at the top of the page, and oldest at the bottom. The events may be displayed in a calendar format according to an embodiment of the invention. Auction software 2008 may set up the following perimeters to configure an auction for the seller, either through an administrator or automatically in communication with the seller: seller(s) associated with sale, name, date of sale, time of sale, date of catalog visibility, description, access groups, buy fee structure, payment methods, transport options, settlement information, countdown, time between vehicles, time after close of event to reset preferences, bid increment, active/inactive flag, and/or event logo.

The parameters may be configured as follows according to an embodiment. With respect to the name, the administration software may have a field that allows for free-form entry of a name for the event. With respect to date of sale, the administration software may have a date field which sets the date which the event will run. With respect to time of sale, the administration software may have a pull-down list of times (broken down by hours) at which point the event will begin. With respect to date of catalog visibility, the administration software may set the date on which the catalog of vehicles will become available to a buyer. Before the catalog is visible, the buyers may not be able to see the event on the auction calendar page. On the other hand, the seller of the event may be able to see the event as soon as it is created by the administration software. The description may be a free-text field in which the administrator can enter text or HTML to describe the details of the sale. This description field may appear at the top of the auction catalog page. With respect to access groups, this may comprise a list of access groups that will display. From the list, the administrator can choose which buyers are able to access the event. Only buyers in the access groups set for the event can see the event on their auction calendar. Multiple access groups may be set for the event.

With respect to the buy fee structure, this may be set to a similar buy fee structure as used for sales. The fee may be a fixed price, a percentage of the buy price, or tiered-fee amount specified for the sale.

With respect to payment methods, the administrator may be able to choose whether a payment method is required for the event. If a payment method is required, then the administrator user can select at least one payment method from the list when configuring the event. The list of all available payment methods may display, with the ability to add a description next to the payment method, and such a similar approach may be used in post-sales. Multiple payment methods may be set for the event.

With respect to transport options, a list of available transport option methods may be listed, with the ability to enter a description next to each one. For transport arranged by the service provider that provides auction server 2001, a transport matrix may be selected. Buyer-arranged transport may be selected with other transport methods.

With respect to settlement information, a pull-down list of settlements may be displayed. One settlement may be selected per event according to an embodiment of the invention. With respect to countdown, this may comprise a numeric field which configures how much time is allowed for additional bids to be placed for a vehicle. For example, if this is set to 30 seconds, the countdown clock starts counting down starting at 30 seconds. If an additional bid is placed, the countdown clock resets to 30 seconds. If no additional bids are placed, the auction will move to the next vehicle in the run order. This may comprise a dropdown pick-list of values.

With respect to time between items auctioned (vehicles), this may comprise a numeric field, in which the number of seconds that should elapse between each sequential listing of a vehicle are set. Time entered impacts the time elapsed between the close of an auction to the next vehicle appearing. A default value may be provided, such as 10 seconds according to an embodiment. This time between vehicles may be provided as a dropdown pick-list of values.

With respect to time after close of event to reset preferences, such time may be configurable. The interface for this may comprise a numeric field, in which the number of minutes are set that determine the length of time after an event ends that a buyer is allowed to reset their transport and payment preferences.

With respect to bid increment, this allows a bid increment to be set per event. This may comprise a list of values, for example, from $25 to $1,000 in $25 increments.

With respect to the active/inactive flag, if this flag is inactive, the event does not appear in the calendar, for either the buyer or the seller. With respect to the event logo, a logo may be associated with the event. This logo may comprise a logo of the seller organization. It should display on the catalog page and on the console.

The auction server 2001 may include software to allow system administrators to manage bidding events. An administrator with a system configuration permission may have access to real-time events through a link under a “managed vehicle” link which lists events. Events may be listed on private label sites, following the same ordering rules as for a seller listing of events. When the system administrator clicks on an event, the administrator can see and has access to functionality that the seller has plus additional permission(s), such as the ability to set the opening price. A system administrator version of a pre-event function to set a reserve price in a catalog page may include the ability to set an opening bid price on the catalog. When the system administrator clicks on the link to set the prices, an additional box is shown, to set the level of the reserve price, and the opening price can be set in this box.

Buyers may be able to update their preferences on purchases in the time between the close of the individual vehicle's auction and to a set amount of time after the close of an auction (for example, one hour to start). As a result, these vehicles may not move to the post-sales system until the end of this time period, to prevent assigning transport for a vehicle until it is determined the buyer is using transport arranged by the service provider, nor does the system start the payment follow-up process until the buyer has set a final choice. One embodiment of the system runs a job on an hourly basis which populates the post-sales system. This approach may involve a delay such as a delay up to 59 minutes. For example, an auction ends at 2:01 PM and the buyer has 2 hours to set his preferences. This would mean that no more changes would be allowed as of 4:01 PM.

Otherwise, the vehicle should follow the applicable post-sale workflow, based on their preferences for transport, payment and title handling, as is currently the case in the production ATC systems.

The system may use various forms of auction logic. For example, in one embodiment, the auction system uses English auctions. The seller or administrator is allowed to set an opening price at a reserve price. Users may bid the highest price they are willing to pay for an item. Participants may attempt to capture the high bid position by placing a bid at the minimum amount or by entering a manual hard bid. The time left for bidding in the auction may be reset each time a bid is placed. If no bids are placed, the auction can count down until time expires. The winning bidder is the bidder who has the highest bid when the auction closes. If the reserve price has been met, the winning bidder is awarded the item. Each bid placed is viewable from the bid history link (for example, via an edit vehicle work page). The following is an example of a system implementing bidding from the lane:
1. The auction begins with an Opening Price of $100.
   a. Bid increments are $50
   b. There is no Reserve Price
2. The minimum bid amount is $100.
3. Bidder #1 places a bid at the opening price of $100 by clicking the minimum bid button.
4. Bidder #1 is currently the high bidder @ $100.
5. The minimum bid amount is $150.
6. Bidder #2 attempts to place a manual bid of $160. The bid is rejected by the system because the bid does not have a $50 increment.
7. Bidder #1 is currently the high bidder @ $100.
8. The minimum bid amount is $150.
9. Bidder #2 places a bid of $150 by clicking the minimum bid button.
10. Bidder #2 is currently the high bidder @ $150.
11. The minimum bid amount is $200.
12. No additional bids are placed and the auction ends.
13. Bidder #2 is the winning bidder @ $150 and is awarded the vehicle because the Reserve Price has been met.
14. The system counts a total of 2 bids placed and 2 unique bidders.

The following is another example of a system implementing bidding from the lane:
1. The auction begins with an Opening Price of $100.
   a. Bid increments are $50
   b. Reserve Price=$5,000
2. The minimum bid amount is $100.
3. Bidder #1 places a manual bid of $500.
4. Bidder #1 must confirm his bid because it is more than double the current minimum bid amount. Bidder #1 confirms his bid.
5. Bidder #1 is currently the high bidder @ $500.
6. The minimum bid amount is $550.
7. Bidder #2 places a bid of $550 by clicking the minimum bid button.
8. Bidder #2 is currently the high bidder @$550.
9. The minimum bid amount is $600
10. Bidder #3 places a manual bid of $400. The bid is rejected by the system because the bid is less than the current bid amount.
11. Bidder #2 is still currently the high bidder @$550.
12. The minimum bid amount is $600
13. No additional bids are placed and the auction ends.
14. Bidder #2 is the high bidder of the auction @ $550, but is not awarded the vehicle because the Reserve Price was not met.
15. The system counts a total of 2 bids placed and 2 unique bidders.

The following is another example of a system implementing bidding from the lane:
1. The auction begins with an Opening Price of $5,000.
   a. Bid increments are $100
   b. Reserve Price=$7,000
2. The minimum bid amount is $5,000.
3. Bidder #1 places a manual bid amount of $7,000
4. Bidder #1 is currently the high bidder @ $7,000
5. The Reserve Price has been met
6. The minimum bid amount is $7,100
7. Bidder #2 places a bid by clicking the minimum bid button
8. Bidder #3 places a bid by clicking the minimum bid button
9. Bidder #4 places a bid by clicking the minimum bid button
10. The system receives Bidder #3's bid first
11. The system rejects Bidder #2's bid as well as Bidder #4's bid.
12. Bidder #3 is currently the high bidder @ $7,100
13. No additional bids are placed and the auction ends.
14. Bidder #3 is the high bidder of the auction @ $7,100 and is awarded the vehicle because the Reserve Price has been met.
15. The system counts a total of 2 bids placed and 2 unique bidders.

An absentee bid may comprise a bid that is placed during the pre-event phase. During the auction lane event, the system automatically raises the absentee bid against competing bids from the lane.

The auction may comprise, according to an embodiment, an auction of a single vehicle available for purchase. The auction lane event may comprise a bidding event where bidders place bids against each other in a simulated “real-time” environment. The auction lane event may have one or more auctions. An auction lane event may have a different start time, but may not have a finite end time.

The system may use an if-bid, which comprises an interactive process that occurs between a high bidder and seller. The system allows an if-bid to be placed by a high bidder if the reserve price has not been met during the course of the auction.

The system may include functionality for an on the market vehicle. A vehicle becomes on the market if a seller opts to set the reserve price equal to current highest bid.

The following describes some additional alternative embodiments.

For example, with respect to the seller event list, as a seller runs more events, a limited number of time of events may be displayed. For example, display may include only the last three months' worth of events, and other events may be provided on a link page. Other time frames may be used for the display of events, such as six months, 12 months, 18 months or other time frames. The status of vehicles may be listed in the real-time event list. For example, status may include sold/not sold, auction in progress, or awaiting auction, depending on the status of the vehicle and the event. A link noting “in progress” may open on the console.

The system may include the functionality to allow a seller to create and manage event settings without involvement by the system administrator.

Various approaches may be available for vehicle pricing according to various embodiments. For example, a black book or blue book price may display on the pricing page. The reserve price from a system may be presented to the seller on the catalog. Pricing may be editable from a pricing page and through a pricing link from an edit vehicle work page. The seller may have a button to automatically set the bidding reserves at the same amount as the other prices set in the system.

Alternatively, the seller may be able to add or subtract a fixed dollar amount, or change prices by a percentage. The system may allow the seller to set prices automatically at a percentage of a particular price, such as a black book or blue book price.

An alternative method of adding cars to an event may be through an express work page on the system. If the seller has events set up, there may be a new link on the work page, which allows the seller to assign vehicles to an event. Clicking on the new link may take the user to a page listing the various vehicles (e.g., through the VINs, for example with a header that prompts the user to choose an event). A pull-down list of future events for the seller may display. The pull-down list may have a list of the vehicles (e.g., through a display of VINs) that have been in the work list. Sold vehicles may have a status indicating that they are sold and not eligible displayed next to the identification of the respective vehicles. The seller then is able to pick an event to which the vehicle is assigned, and then clicks the appropriate button or link to submit the vehicle. The vehicle is then assigned to the event, and the user is returned to the event, where the user sees the new status of the vehicles. The work list may display the name, date and time of the event to which the vehicle has been assigned. If a reserve price existed from a previous auction record, it may display under a field indicating that this is the previously set reserve price. The previous reserve price set while the vehicle is in an auction life cycle in the system may be displayed in the seller console.

The system may support “if bids.” If bidding on a vehicle does not reach the seller's reserve price, the buyer may be given the option of placing an if bid. This causes a section of the seller console to extend with details regarding the if bid. The details may include the bidder, vehicle information, and bid amount. The seller may be able to provide a counteroffer, which the buyer has one chance to accept, counter it, or refuse, which ends the bidding negotiations, at which point the item becomes no-sale. If the bidder counters, the seller can then accept the offer, which will sell the vehicle to the bidder at the counter amount or refuse, which will cause the vehicle not to be sold.

According to an embodiment, the seller has a button that allows the seller to cancel the auction. This option may involve a confirmation by the seller indicating that the seller is sure that the seller wants to cancel the auction. As a result of this selection, the system may post a message to the buyer that the auction for the vehicle has been cancelled and that the vehicle is no longer available for the auction. The vehicle may move to the no-sale status. The auction may then move to the next vehicle in the run order.

The user may be able to select the disposition of the vehicle in accordance with the following. If the vehicle has been in an auction status prior to the vehicle being listed in an event, then the seller may be able to click a link that allows the seller to choose the disposition. A link takes the user to a page where the user can select the disposition of the vehicle. Options for this disposition may include moving the vehicle to a no-sale status (this may generate a record back to the seller's system that the vehicle has been moved to a no-sale status), or returning the vehicle to life cycle (The system may display in parentheses an auction run number that the vehicle was in before the sale. Clicking this link may return the vehicle to the beginning of the run that it was removed from and restore the car group configuration setting of the vehicle.).

Absentee bidding may be supported. If absentee bidding is activated for an auction lane event, the user may be allowed to place an absentee bid. If a user enters multiple bids, the most recent bid is the bid that can be used for the live event. In this instance, only a bid placed above the opening price is accepted by the system. If the user attempts to place a bid that is lower than the opening price, the user may receive an error message indicating that bids placed must be greater than or equal to the opening price. If a user enters a bid greater than or equal to the opening price, the bid may be displayed as the user's absentee bid. A user can delete the user's absentee bid by entering a value of zero according to an embodiment. A user may also be able to enter and save absentee bids regardless of absentee bids placed by other users.

According to an embodiment, the user may be able to mute all sounds on the bidding console.

The system may include a display regarding the vehicle's condition. For example, the system may display a green, yellow and/or red light equivalent indicating the condition as good, moderate, or bad respectively, or other tiers of conditions. The information comes from the condition report according to an embodiment.

According to an embodiment, the system provides keyboard shortcuts. Using a combination of keystrokes, the user is able to initiate certain actions from the bidding console. According to an embodiment, the keystrokes may include the following, in various combinations:
Alt+b: The focus is set to the text box where the user can enter a manual bid amount,
Alt+n: The notes tab of the bidding console is displayed,
Alt+p: The tab which contains the vehicle thumbnail photos is displayed,
Alt+m: All sound is muted from the bidding console,
Alt+d: The details tab for the current vehicle will be displayed.

According to an embodiment of the invention, the system may allow multiple sellers to be associated with the sale. The multiple sellers may be associated with the sale by access groups or individually chosen organizations.

An embodiment of the invention may allow for pre-bidding yes or no. Such a setting may determine whether or not bids can be placed from the auction calendar page. If no, then the bids may be placed during a real-time bidding event. If yes, then the buyer will be able to place a proxy bid until the start time of a bidding event.

The system may include support of a merchandising banner. For example, a free text field may be included which includes an advertising banner. The free text field may be entered by an administrator, and may be in HTML format according to an embodiment. The banner may display on the catalog page and in the buyer and seller consoles, or in a combination of the foregoing.

A system administrator may have access to a special console in which the administrators can monitor the auction. The console may be a view-only console. The console may have the same functionality as a seller console with the additional capability to pause and unpause an action.

An embodiment of the system may include support of an event logo. The event logo support may include the ability to upload a logo with a picture upload tool. Such a logo may comprise a logo of the seller organization.

An embodiment of the invention may support absentee bidding. An absentee bid may be placed automatically at the current minimum bid amount if no bids are placed live from the auction lane. According to an embodiment, the absentee bid may be placed when only a certain amount of time (e.g., one second) remains in the auction. The system may allow time for a bidder in the lane to place a bid first. If no bids from the lane are placed, the system may place an absentee bid. This process may continue until the reserve price has been met or the maximum absentee amount has been reached. If a bid is placed from the lane, the system will accept the competing bid and may raise the absentee bid by one increment. In the event a bid from the lane matches the maximum absentee amount, the bid from the lane is counted as the high bid. The tie goes to the bidder in the lane. In situations where multiple absentee bids have been placed on the same item, both absentee bids may compete against each other. Ties will be awarded to the bidder who has placed the highest absentee bid. In cases where there is a tie between absentee bids, the absentee bid that has been placed first may assume the position of high bid.

The following is another example of such bidding:
1. During the Pre-Event phase Bidder #1 places an absentee bid of $5,500
2. The auction begins with an Opening Price of $5,000.
   a. Bid increments are $100
   b. Reserve Price=$5,200
3. No bids are placed.
4. With 1 second remaining, the system automatically places a bid of $5,000 for Bidder #1
5. Bidder #1 is currently the high bidder @ $5,000
6. The minimum bid amount is $5,100
7. No competing bids are placed.
8. With 1 second remaining, the system automatically places a bid of $5,100 for Bidder #1
9. Bidder #1 is the current high bidder @ $5,100
10. The minimum bid amount is $5,200
11. No competing bids are placed
12. With 1 second remaining, the system automatically places a bid of 5,200 for Bidder #1
13. Bidder #1 is the current high bidder @ $5,200
14. The Reserve Price has been met
15. The minimum bid amount is $5,200
16. No bids are placed and the auction ends
17. Bidder #1 is the high bidder of the auction @ $5,200 and is awarded the vehicle
18. The system counts a total of 3 bids placed and 1 unique bidder.

The following is another example of bidding:
1. During the Pre-Event phase Bidder #1 places a absentee bid of $5,200
2. The auction begins with an Opening Price of $5,000
   a. Bid increments are $100
   b. Reserve Price=$6,000
3. No bids are placed.
4. With 1 second remaining, the system automatically places a bid of $5,000 for Bidder #1
5. Bidder #1 is currently the high bidder @ $5,000
6. The minimum bid amount is $5,100
7. No competing bids are placed.
8. With 1 second remaining, the system automatically places a bid of $5,100 for Bidder #1
9. Bidder #1 is the current high bidder @ $5,100
10. The minimum bid amount is $5,200
11. No competing bids are placed
12. With 1 second remaining, the system automatically places a bid of 5,200 for Bidder #1
13. Bidder #1 is the current high bidder @ $5,200
14. The minimum bid amount is $5,300
15. No bids are placed and the auction ends
16. Bidder #1 is the high bidder of the auction @ $5,200 but is not awarded the vehicle because the Reserve Price has not been met.
17. The system counts a total of 3 bids placed and 1 unique bidder.

The following is another example of bidding:
1. During the Pre-Event phase Bidder #1 places an absentee bid of $6,000
2. The auction begins with an Opening Price of $5,000.
   a. Bid increments are $100
   b. Reserve Price=$5,200
3. No bids are placed.
4. With 1 second remaining, the system automatically places a bid of $5,000 for Bidder #1
5. Bidder #1 is currently the high bidder @ $5,000
6. The minimum bid amount is $5,100
7. Bidder #2 places a bid of $5,100 by clicking the minimum bid button
8. Bidder #2 is currently the high bidder @ $5,100
9. The minimum bid amount is $5,200
10. The system prevents bidders in the lane from placing a bid while it automatically raises Bidder #1's bid to $5,200
11. Bidder #1 is currently the high bidder @ $5,200
12. The Reserve Price has been met
13. The minimum bid amount is $5,300 and bidding from the lane is now permitted
14. Bidder #3 enters a manual bid of $6,000
15. Bidder #3 is the current high bidder at $6,000
16. The minimum bid amount is $6,100
17. Bidder #2 places a bid of $6,100 by clicking the minimum bid button
18. Bidder #2 is currently the high bidder @ $6,100
19. The minimum bid amount is $6,200
20. No additional bids are placed and the auction ends.
21. Bidder #2 is the high bidder of the auction @ $6,100 and is awarded the vehicle
22. The system counts 5 bids placed and 3 unique bidders

The following is another example of bidding:

1. During the Pre-Event phase Bidder #1 places an absentee bid of $5,200 24 hours before the start of Auction Lane event.
2. During the Pre-Event phase Bidder #2 places an absentee bid of $5,200 12 hours before the start of the Auction Lane event.
3. The auction begins with an Opening Price of $5,000.
   a. Bid increments are $100
   b. Reserve Price is $5,200
4. No bids are placed
5. With 1 second remaining, the system automatically places a bid of $5,200 for Bidder #1 (Bidder #1's bid is counted as the high bid because he placed his bid first)
6. Bidder #1 is currently the high bidder @ $5,200
7. The Reserve Price has been met
8. The minimum bid amount is $5,300
9. No additional bids are placed and the auction ends
10. Bidder #1 is the high bidder of the auction @ $5,200 and is awarded the vehicle
11. The system counts 2 bids placed and 2 unique bidders. (The bid history for this auction should display both absentee bids with the tie bid amounts)

The following is another example of such bidding:
1. During the Pre-Event phase Bidder #1 places a pre-bid of $5,400
2. During the Pre-Event phase Bidder #2 places a pre-bid of $5,200
3. The auction begins with an Opening Price of $2,000.
   a. Bid increments are $100
   b. Reserve Price is $8,000
4. No bids are placed
5. With 1 second remaining, the system automatically places a bid of $5,200 for Bidder #2.
6.Bidder #2 is the current high bidder
7. The minimum bid amount is $5,300
8. The system prevents bidders in the lane from placing bids while it automatically raises Bidder #1's bid to $5,300.
9. Bidder #1 is currently the high bidder @ $5,300
10. The minimum bid amount is $5,400 and bidding from the lane is permitted by the system
11. No bids are placed.
12. With 1 second remaining, the system places a bid of $5,400 for Bidder #1
13. Bidder #1 is currently the high bidder @ $5,400
14. No additional bids are placed and the auction ends
15. Bidder #1 is the high bidder of the auction @ $5,400 but is not awarded the vehicle because the Reserve Price has not been met.
16. The system counts 3 bids placed and 2 unique bidders.

The following is another example of such bidding:
1. During the Pre-Event phase Bidder #1 places an absentee bid of $5,500
2. During the Pre-Event phase Bidder #2 places an absentee bid of $5,200
3. During the Pre-Event phase Bidder #3 places an absentee bid of $6,000
4. The auction begins with an Opening Price of $2,000.
   a. Bid increments are $100
   b. Reserve Price is $6,000
5. No bids are placed
6. With 1 second remaining, the system prevents any bids from being placed in the lane and automatically places a bid of $5,200 for Bidder #2.
7. The system then places a bid of $5,500 for Bidder #1
8. The system then places a bid of $5,600 for Bidder #3
9. Bidder #3 is the current high bidder @ $5,600
10. The minimum bid amount is $5,700 and bidding from the lane is now permitted
11. Bidder #4 places a bid at the minimum bid amount of $5,700
12. Bidder #4 is the current high bidder @ $5,700
13. The minimum bid amount is $5,800
14. The system prevents any bids from being placed in the lane while it automatically raises Bidder #3's bid to $5,800.
15. Bidder #3 is the current high bidder @ $5,800
16. The minimum bid amount is $5,900 and bidding from the lane is now permitted
17. No bids are placed
18. With 1 second remaining, the system prevents any bids from being placed in the lane while it automatically raises Bidder #3's bid to $5,900.
19. Bidder #3 is the current high bidder @ $5,900
20. The minimum bid amount is $6,000 and bidding from the lane is now permitted.
21. Bidder #4 places a bid at the minimum bid amount of $6,000
22. Bidder #4 is the current high bidder @ $6,000.
23. The minimum bid amount is $6,100
24. No additional bids are placed and the auction ends.
25. Bidder #4 is the high bidder of the auction @ $6,000 and is awarded the vehicle
26. The system counts 7 bids placed and 4 unique bidders.

An embodiment of the invention is directed to a method of managing a network-based auction system for vehicles. Information regarding a set of vehicles to be auctioned in an auction event is received from a seller through an electronic interface.

A list of the vehicles to be auctioned is displayed on an interface for the seller. The seller is provided an option to determine an order in which the vehicles are to be made available to buyers for bidding on an interface on which the list is displayed.

Input is received from the seller regarding the order, and the vehicles are made available to buyers for bidding in the order determined by the seller.

According to an embodiment, each vehicle may be made available for a first limited time, and the respective vehicle may be made available for bidding for an additional time only if a bid is received. According to another embodiment, the additional time is equal to the first limited time. The first limited time may comprise 30 seconds according to an embodiment of the invention.

According to an embodiment, an input is presented next to each item in the list of vehicles presented to the seller. In the input the seller is prompted to select the order in which the respective vehicle is to be made available for bidding. In advance of making the vehicles available for bidding, a list of vehicles showing the order in which the vehicles will be available for bidding may be presented to the buyer.

Another embodiment of the invention is directed to a computer network-based auction system for vehicles. The system includes logic that receives over a network from a seller information regarding a set of vehicles to be auctioned in an auction event. The system also includes logic that provides a list of vehicles to be auctioned for display on an interface for the seller, and logic that provides a seller, on the interface on which the list is displayed, an option to determine an order in which the vehicles are to be made available to buyers for bidding. The system further may include logic that receives input from the buyer regarding the order and logic that makes the vehicles available to buyers for bidding in the order determined by the seller.

Another embodiment of this invention is directed to a computer network-based auction system for vehicles. The system includes a seller system, which includes logic that receives information from a seller regarding a set of vehicles to be auctioned in an auction event and a graphical display listing the vehicles to be auctioned. The seller system also includes, on the display listing the vehicles, an input through which a seller may determine an order in which the vehicles are to be made available to buyers for bidding. The system further includes a database for a vehicle inventory and an auction server coupled to the database and the seller system. The auction server includes logic that receives input from the seller regarding vehicles to be auctioned and to store information regarding the vehicles in the database. The auction server further includes logic that receives input from the seller regarding the order in which the vehicles are to be made available to buyers for bidding and logic that makes the vehicles available to buyers for bidding in the order determined by the seller.

Another embodiment of the invention is directed to a method of managing a network-based auction system. The method includes receiving from a seller through an electronic interface information regarding a set of items to be auctioned in an auction event. A list of the items to be auctioned is displayed on an interface for the seller, and on the interface on which the list is displayed, the seller is provided an option to determine an order in which the items are to be made available to buyers for bidding.

An input is received from the seller regarding the order, and the items are made available to buyers for bidding in the order determined by the seller. The items may comprise vehicles, or items for auction other than vehicles, according to various embodiments.

According to an embodiment, a buyer is provided an option to provide a bid below a reserve price if bidding does not reach the reserve price.

Another embodiment of the invention is directed to a method of providing an auction for items over a computer network. User interfaces are provided for a buyer so they may participate in the auction over the computer network. Information regarding the items that are in the auction is provided on the user interfaces, and an input is provided on the user interfaces for the buyer to provide a question for the seller. The question is received from a particular buyer from among the buyers. A user interface is provided for the seller, and the question is displayed to the seller on the seller's user interface. An answer is received to the question from the seller through the seller's user interface, and the answer is displayed on the user interfaces of a set of buyers who are participating in the auction for the items.

According to an embodiment, the question pertains to an item in the auction and the answer is displayed on the user interfaces of all buyers who are participating in the auction of the item to which the question pertains. According to an embodiment, the answer is displayed on the user interfaces of all buyers who are participating in the auction. According to another embodiment, an auction lane catalog is provided, and the answer is displayed on the answer lane catalog. According to another embodiment, the question is displayed without identifying the buyer, and according to another embodiment of the invention the input on the user interfaces for the buyers to provide a question for the seller includes input for text. According to yet another embodiment, the input on the user interfaces for the buyer to provide a question for the seller includes a set of choices among which the buyer may select.

According to an embodiment, an input is provided on the user interfaces for the buyers to provide the question for the seller during a time before commencement of the auction, and the input is disabled after commencement of the auction. According to another embodiment, the input is provided on the user interfaces for buyers to provide the question for the seller including during a time after commencement of the auction.

Another embodiment of the invention is directed to a method of providing an auction for items over a computer network in which a question is received from a particular buyer from among the buyers, and the answer to the question is displayed on the user interfaces of all the buyers who are participating in the auction.

Another embodiment of the invention is directed to a computer network-based system that includes logic that sends information regarding items for auction to buyers who participate in an auction over a computer network. The system includes logic that receives from at least a buyer a question regarding an aspect of the auction. The system also includes logic that automatically sends the question to the seller over the computer network. Additionally, the system may include logic that receives over the computer network an answer to the question from the seller and logic that sends over a computer network the answer to the buyers who participate in the auction.

Another embodiment of the invention is directed to a method of providing an auction for vehicles over a computer network. The method includes providing user interfaces for buyers who may participate in the auction over the computer network. Information is provided on the user interfaces regarding the vehicles that are in the auction. An input is provided on the user interfaces for buyers to provide a question for the seller. The question is received from a particular buyer from among the buyers. A user interface is provided for the seller, and the question is displayed to the seller on the seller's user interface. An answer is received to the question from the seller through the seller's user interface, and the answer is displayed on the user interfaces of a set of buyers who are participating in the auction for the vehicles.

According to an embodiment of the invention, the question pertains to a vehicle in the auction and the answer is displayed on the user interfaces of all buyers who are participating in the auction of the vehicle to which the question pertains.

Another embodiment of the invention is directed to a console for a participant in a network-based auction system. A first section of the console includes information regarding an item on which bidding is currently taking place and a visual representation of the item on which bidding is currently taking place. A second section of the console includes information regarding an item in the auction and a visual representation of the item. The console includes an input for causing the second section of the console to display a different item in the auction and display a set of recent bids placed for the item currently being auctioned. According to an embodiment, the second section of the console has display of a plurality of photos of the item.

According to an embodiment, the console includes an input to cause the second section of the display to toggle to information regarding, and a visual representation of, the item in the auction after the item currently displayed in the second section of the display. The console additionally may include an input to cause the second section of the display to toggle to information regarding, and a visual representation of, the item in the auction before the item currently displayed in the second section of display.

According to an embodiment of the invention, the console includes an input to cause the second section of the display to toggle directly to information regarding, and a visual representation of, the item currently being auctioned. According to another embodiment of the invention, the display of a set of recent bids placed for the item currently being auctioned changes to add new bids as new bids are placed. The console may include a free form input for a bid from a buyer. Alternatively or additionally, the console may include an input for a bid from a buyer where the bid or a set of bids are ones among which the user may select. According to another embodiment of the invention, the console may include an input for a buyer to place a bid, wherein the bid has a computer generated bid amount. The computer generated bid amount may comprise an automatically generated amount above the current bid.

According to an embodiment of the invention, the console may include a graphical display showing a representation of relative progress through the auction. The graphical display may comprise a linear display that changes in length to show relative progress through the auction. According to an embodiment, the console includes a countdown clock that indicates time available to place bids for the item currently being auctioned. The console may also include an input to cause detailed information to be displayed in another portion of the console regarding an item in the auction.

According to an embodiment, the item may comprise a vehicle, and the information regarding the item may comprise a vehicle identification number.

Another embodiment of the invention is directed to a method of providing an auction for vehicles over a computer network. Information regarding an item on which bidding is currently taking place and a visual representation of the item on which bidding is currently taking place is displayed. Information regarding an item in the auction and a visual representation of the item is separately displayed, and in response to a user input, a different item is displayed in place of the information and visual representation that was separately displayed regarding the item in the auction. A set of recent bids placed for the item currently being auctioned is displayed, and the set of recent bids is updated as new bids are placed.

Another embodiment of the invention is directed to a computer network-based auction system including a console for a participant in the auction. The console includes a first section including information regarding an item on which bidding is currently taking place and a visual representation of the item on which bidding is currently taking place. The second section of the console includes information regarding an item in the auction and the visual representation of the item. The console includes an input for causing the second section of the console to display a different item in the auction and a display of a set of recent bids placed for the item currently being auctioned. The system includes a database for inventory and an auction server coupled to the database and the console. The auction server includes logic that receives input from a seller regarding items to be auctioned and logic that stores information regarding the items in the database The auction server also includes logic that receives input from the console regarding an item about which the user wishes to receive information and retrieves information from the database. The auction server further includes logic that transmits the received information to the console for display to the user.

According to an embodiment of the invention, the system includes a plurality of servers having consoles for buyers and at least a server having a console for a seller. The console may comprise computer code, electronic hardware, or a combination of computer code and electronic hardware. The items may comprise vehicles, and the information may comprise vehicle identification numbers (VINs).

Another embodiment of the invention is directed to a console for a participant in a network-based vehicle auction system. A first section of the console includes information including a VIN regarding a vehicle on which bidding is currently taking place and a photo of the vehicle on which bidding is currently taking place. The second section of the console includes information regarding another vehicle in the auction and a photo of the other vehicle. The console includes an input for causing the second section of the console to display a different vehicle in the auction and a display of a set of recent bids placed for the vehicle currently being auctioned.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the systems and methods include: microcontrollers with memory, embedded microprocessors, firmware, software, etc. Furthermore, aspects of the systems and methods may be embodied in microprocessors having software-based circuit emulation, discrete logic (sequential and combinatorial), custom devices, fuzzy (neural network) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that the various functions or processes disclosed herein may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, email, etc.) over the Internet and/or other computer networks via one or more data transfer protocols (e.g., HTTP, FTP, SMTP, etc.). When received within a computer system via one or more computer-readable media, such data and/or instruction-based expressions of components and/or processes under the systems and methods may be processed by a processing entity (e.g., one or more processors) within the computer system in conjunction with execution of one or more other computer programs.

Unless the context clearly requires otherwise, throughout the description and the claims, the words ‘comprise,’ ‘comprising,’ and the like are to be construed in an inclusive sense as opposed to an exclusive or exhaustive sense; that is to say, in a sense of ‘including, but not limited to.’ Words using the singular or plural number also include the plural or singular number respectively. Additionally, the words ‘herein,’ ‘hereunder,’ ‘above,’ ‘below,’ and words of similar import refer to this application as a whole and not to any particular portions of this application. When the word ‘or’ is used in reference to a list of two or more items, that word covers all of the following interpretations of the word: any of the items in the list, all of the items in the list and any combination of the items in the list.

The above description of illustrated embodiments of the systems and methods is not intended to be exhaustive or to limit the systems and methods to the precise form disclosed. While specific embodiments of, and examples for, the systems and methods are described herein for illustrative purposes, various equivalent modifications are possible within the scope of the systems and methods, as those skilled in the relevant art will recognize. The teachings of the systems and methods provided herein can be applied to other processing systems and methods, not only for the systems and methods described above.

The elements and acts of the various embodiments described above can be combined to provide further embodiments. These and other changes can be made to the systems and methods in light of the above detailed description.

In general, in the following claims, the terms used should not be construed to limit the systems and methods to the specific embodiments disclosed in the specification and the claims, but should be construed to include all processing systems that operate under the claims. Accordingly, the systems and methods are not limited by the disclosure, but instead the scope of the systems and methods is to be determined entirely by the claims.

While certain aspects of the systems and methods are presented below in certain claim forms, the inventors contemplate the various aspects of the systems and methods in any number of claim forms. Accordingly, the inventors reserve the right to add additional claims after filing the application to pursue such additional claim forms for other aspects of the systems and methods.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to an embodiments of the invention described herein may be employed in practicing the invention. It is intended that the following claims define the scope of the invention and that methods and structures within the scope of these claims and their equivalents be covered thereby.

What is claimed is:

1. A method of managing an internet-based auction system for vehicles, the method comprising:
receiving from a seller through an electronic interface information regarding a set of vehicles to be auctioned in an auction event;
displaying a list of the vehicles to be auctioned on an interface for the seller;
on the interface on which the list is displayed, providing the seller an option to determine an order in which the vehicles are to be made available to buyers for bidding;
receiving input from the seller regarding the order; and
making the vehicles available to buyers for bidding in the order determined by the seller.

2. The method of claim 1, including making each vehicle available for bidding for a first limited time, and making the respective vehicle available for bidding for additional time only if a bid is received.

3. The method of claim 2, wherein the additional time is equal to the first limited time.

4. The method of claim 2, wherein the first limited time comprises 30 seconds.

5. The method of claim 1, including presenting an input next to each item in the list of vehicles presented to the seller, in which input the seller is prompted to select the order in which the respective vehicle is to be made available for bidding.

6. The method of claim 1, including in advance of making the vehicles available for bidding, presenting to the buyer a list of the vehicles showing the order in which the vehicles will be available for bidding.

7. A computer network-based auction system for vehicles, the system comprising:
logic that receives over a network from a seller information regarding a set of vehicles to be auctioned in an auction event;
logic that provides a list of the vehicles to be auctioned for display on an interface for the seller;
logic that provides the seller, on the interface on which the list is displayed, an option to determine an order in which the vehicles are to be made available to buyers for bidding;
logic that receives input from the seller regarding the order; and
logic that makes the vehicles available to buyers for bidding in the order determined by the seller.

8. The system of claim 7, including logic that makes each vehicle available for bidding for a first limited time, and makes the respective vehicle available for bidding for additional time only if a bid is received.

9. The system of claim 8, wherein the additional time is equal to the first limited time.

10. The system of claim 8, wherein the first limited time comprises 30 seconds.

11. The system of claim 7, including logic that presents an input next to each item in the list of vehicles presented to the seller, in which input the seller is prompted to select the order in which the respective vehicle is to be made available for bidding.

12. The system of claim 7, including logic that in advance of making the vehicles available for bidding, presents to the buyer a list of the vehicles showing the order in which the vehicles will be available for bidding.

13. A computer network-based auction system for vehicles, the system comprising:
a seller system, the seller system including,
logic that receives information from a seller regarding a set of vehicles to be auctioned in an auction event;
a graphical display listing the vehicles to be auctioned;
on the display listing the vehicles, an input through which a seller may determine an order in which the vehicles are to be made available to buyers for bidding;
a database for vehicle inventory; and
an auction server coupled to the database and the seller system, the auction server including
logic that receives input from the seller regarding vehicles to be auctioned and to store information regarding the vehicles in the database;
logic that receives input from the seller regarding the order in which the vehicles are to be made available to buyers for bidding; and
logic that makes the vehicles available to buyers for bidding in the order determined by the seller.

14. The system of claim 13, including logic in the auction server that makes each vehicle available for bidding for a first limited time, and makes the respective vehicle available for bidding for additional time only if a bid is received.

15. The system of claim 14, wherein the additional time is equal to the first limited time.

16. The system of claim 14, wherein the first limited time comprises 30 seconds.

17. The system of claim 13, the seller system including logic that presents an input next to each item in the list of vehicles presented to the seller, in which input the seller is prompted to select the order in which the respective vehicle is to be made available for bidding.

18. The system of claim 13, the seller system including logic that in advance of making the vehicles available for bidding, presents to the buyer a list of the vehicles showing the order in which the vehicles will be available for bidding.

19. The system of claim 13, the database including a data structure for the seller including a list of items in the seller's inventory.

20. The system of claim 13, the database including a catalog for the auction.

21. A method of managing a network-based auction system, the method comprising:
receiving from a seller through an electronic interface information regarding a set of items to be auctioned in an auction event;
displaying a list of the items to be auctioned on an interface for the seller;
on the interface on which the list is displayed, providing the seller an option to determine an order in which the items are to be made available to buyers for bidding;
receiving input from the seller regarding the order; and
making the items available to buyers for bidding in the order determined by the seller.

22. The method of claim 21, including presenting an input next to each item in the list of items presented to the seller, in which input the seller is prompted to select the order in which the respective item is to be made available for bidding.

23. The method of claim 21, including in advance of making the items available for bidding, presenting to the buyer a list of the items showing the order in which the items will be available for bidding.

24. The method of claim 21, including providing at least a buyer an option to provide a bid below a reserve price if bidding does not reach the reserve price.
